(19) United States
(12) Patent Application Publication
(10) Pub. No.: US 2012/0234470 A1
(43) Pub. Date: Sep. 20, 2012

(54) LAMINATE FILM FOR COATING METAL SHEET, AND LAMINATE FILM FOR COATING METAL SHEET FOR SCREEN BOARD

(75) Inventors: Yoshihiko NISHIO, Shiga (JP); Yoshio WAKAYAMA, Shiga (JP); Toshiaki EBITANI, Shiga (JP)

(73) Assignee: Mitsubishi Plastics, Inc., Tokyo (JP)

(21) Appl. No.: 13/443,075

(22) Filed: Apr. 10, 2012

Related U.S. Application Data
(62) Division of application No. 11/913,927, filed on Nov. 8, 2007, now abandoned.

(30) Foreign Application Priority Data
May 10, 2005 (JP) 2005-137905

(51) Int. Cl. B32B 37/02; B32B 37/14

(52) U.S. Cl. 156/182; 156/244.11

(57) ABSTRACT

The present invention provides a laminate film for coating metal sheet for screen board comprising: a layer of which elastic modulus at 180° C.˜200° C. is 1.0×10⁷ Pa or less and elastic modulus at 120° C.˜160° C. is 1.0×10⁸ Pa or more, and a layer consisting of a fluorine resin thereon. The laminate film for coating metal sheet for screen board has excellent writing-and-drawing property, erasability, and anti-glare property; the laminate film can be economically manufactured by reducing the usage of fluorine resin; the laminate film also can be efficiently manufactured by reducing the steps for laminating with adhesive; and it can prevent the reversion of embossing of the film surface.

### TECHNICAL FIELD

The present invention relates to a laminate film for coating metal sheet which has antifouling property and in which individual layers thereof are thinner than those of conventional layers. Specifically, the present invention relates to a laminate film for coating metal sheet for screen board having functions as a marker board and as the screen for such as overhead projectors (OHP).

### BACKGROUND ART

A metal sheet coated by a resin film is used for protecting the metal surface from damages or for giving design to the metal surface. The metal sheet coated by the resin film is widely used for: exterior of home electric appliances, steel furniture, interior of elevators, doors, walls of prefabricated bath, ceiling of buildings, and so on.

As such a metal sheet, Patent document 1 discloses a metal sheet on which a synthetic resin film is laminated by use of anti-rust adhesive to which an inorganic series rust inhibitor is added. Patent document 2 discloses a film-coated metal sheet which a metal membrane formed on a polyethylene terephthalate (PET) film and a metal sheet are thermally adhered by an adhesive layer including a high-molecular-weight thermoplastic polyester or a high-molecular-weight thermoplastic polyester ether either of which has a predetermined melting point as a main component. Moreover, Patent document 3 discloses a film-coated metal sheet which a metal sheet and a plastic film are laminated by an adhesive layer having a composition mainly including a ultraviolet-absorbing acrylic series resin.

Further, as a screen board being one of the uses for resin film coated metal sheet, there is one which a fluorine film is laminated on the surface of a white base material. In this screen board, it is possible to write on the surface of the fluorine film with a special marker and to erase the written one.

In order to use these metal sheets for screens of OHP and the like, a sheet is required to have anti-glare property. So as to give anti-glare property, it is necessary to form unevenness in the surface of the fluorine film. As a method for forming unevenness in the film surface, conventionally, silica particles are contained in the fluorine film, or unevenness is formed in the surface of the film by using an emboss-roll right after the film forming.

In Patent document 4, a method for manufacturing a sheet for white board having a step of transferring emboss by pressing an emboss surface of an emboss block into the surface of a fluorine film of a laminate film made by adhering the fluorine film and a white base material together.
Patent Document 1: Japanese Patent Application Laid-Open (JP-A) No. 52-434686
Patent Document 2: JP-A No. 58-183248
Patent Document 3: JP-A No. 8-290525
Patent Document 4: JP-A No. 11-254885

### DISCLOSURE OF THE INVENTION

### Problems to be solved by the Invention

In a metal sheet coated by a resin film, when antifouling property is required, in order to give antifouling property to it, it can be considered to coat the surface of the metal sheet with a laminate film of which most outer layer is a fluorine series resin. In general, such a fluorine series resin is quite expensive; the fluorine series resin layer should be as thin as possible.

However, as seen from Patent documents 1-3, the method for laminating resin by press-forming with adhesive requires the film to have certain rigidity in view of workability for laminating the film, therefore, the fluorine series resin layer needs to have certain thickness. As a result, the resin coated metal sheet cannot be made economically. In addition, as such method requires a step for laminating the film, there are problems in lack of workability and economic inefficiency.

With respect to the screen board, in order to give anti-glare property, unevenness provided in the surface of the fluorine film must satisfy a regular height and pitch. If these are not regular, clogging of ink occurs in some areas where pitch of the unevenness is narrow; there is a problem in erasability as it becomes difficult to wipe written letters and drawings on the board.

Nevertheless, in the above methods for providing unevenness, when silica particles and the like are included in the film, since the pattern of unevenness is determined by the position of particles, the position of the unevenness cannot be regularly adjusted. Therefore, making regular height and pitch of the unevenness is not possible by the above methods. Further, when the pattern of unevenness is formed in the surface of the fluorine film right after forming of the film by use of emboss roll, the fluorine film shrinks because of the sudden temperature difference after the film forming. Hence, making regular height and pitch of the unevenness is not possible.

While, by widening the pitch of unevenness, it is possible to prevent clogging of the ink. However, in this case, anti-glare treatment becomes insufficient; it is not possible to give anti-glare property in the surface of the fluorine film. Moreover, when unevenness is not formed in the surface of the fluorine film, ink of marker is repelled; thereby writing or drawing on the surface of the fluorine film is not possible. Thus, certain unevenness is required from the viewpoint of writing-and-drawing property.

The manufacturing method described in Patent document 1 is provided to solve the above problems. However, in the manufacturing method of Patent document 1, since the fluorine film and the white base material are adhered each other by adhesive, the film to be used is required to have certain rigidity in view of workability for laminating the film, the fluorine film is also required to have certain film thickness.

In general, as the fluorine resin is quite expensive, reduction of the fluorine resin usage is required by making thickness of the fluorine film as thin as possible. However, in the method described in Patent document 1, due to the reasons above, economically manufacturing the screen board by reducing the usage of fluorine resin is impossible. Moreover, because of the step for laminating the film, there is a problem in workability.

While, when unevenness is given in the surface of the laminate film consisting of the fluorine film and the white base material, then the white base material side of the laminate film is thermally laminated on the metal sheet, there is a problem that reversion of the embossed unevenness occurs by the heating at a time of lamination. As desirable emboss cannot be given into the film surface, the screen board has problems in lack of erasability and anti-glare property.

Accordingly, an object of the present invention is to provide a laminate film for coating metal sheet by making the fluorine series resin film thinner, which is capable to provide economic benefit compared with the conventional arts. Further, another object of the present invention is to provide a laminate film for coating metal sheet for screen board and a laminate film coated metal sheet for screen board, these of which has excellent writing-and-drawing property, erasability, and anti-glare property; which can be economically manufactured by reducing the usage of fluorine resin; which can be efficiently manufactured by reducing the steps for lamination with adhesive; and which can prevent the reversion of embossed unevenness of the film surface.

### Means for Solving the Problems

The present invention will be described as below. In order to make the understanding of the invention easier, reference numerals of the attached drawings are quoted in brackets; however, the present invention is not limited by the embodiments shown in the drawings.

The first aspect of the present invention is a laminate film for coating metal sheet for laminating on a metal surface, the laminate film comprising: a non-elongated layer (50) consisting of a polyester series resin; and a layer (20) consisting of a fluorine resin thereon. The wording “non-elongated” means the layer is not elongated on purpose. For example, it does not mean the lack of existence of orientation and the like produced by winding by use of casting-roll at a time of extrusion film making.

In the first aspect of the invention, a printing layer (70) is preferably formed on a side of the non-elongated layer (50) consisting of the polyester series resin, between the non-elongated layer (50) consisting of the polyester series resin and the layer (20) consisting of the fluorine resin.

In the first aspect of the invention, an opposite surface of the layer (20) consisting of the fluorine resin to another surface thereof on which the non-elongated layer (50) consisting of the polyester series resin is laminated preferably has a delaminatable resin layer (60).

The first aspect of the invention can be favorably manufactured by adhering a side of the layer (20) consisting of the fluorine resin of the laminate film formed by co-extrusion having the layer (20) consisting of the fluorine resin and the delaminatable resin layer (60) to the non-elongated layer (50) consisting of the polyester series resin.

The second aspect of the present invention is a laminate film for coating metal sheet for laminating on a metal surface, the laminate film comprising: a non-elongated layer (50) consists of a polyester series resin; a transparent resin layer (80) consisting of a polyester series resin, thereon; and a layer (20) consisting of a fluorine resin on top thereof.

In the second aspect of the invention, the transparent resin layer (80) consisting of the polyester series resin is preferably a transparent elongated layer consisting of a polyester series resin or a transparent non-elongated layer consisting of a polyester series resin.

In the second aspect of the invention, a printing layer (70) is preferably formed on a side of the non-elongated layer (50) consisting of the polyester series resin and/or on a side of the transparent resin layer (80) consisting of the polyester series resin between the non-elongated layer (50) consisting of the polyester series resin and the transparent resin layer (80) consisting of the polyester series resin.

In the second aspect of the invention, an opposite surface of the layer (20) consisting of the fluorine resin to another surface thereof on which the transparent resin layer (80) consisting of the polyester series resin is laminated preferably has a delaminatable resin layer (60).

The laminate film for coating metal sheet according to the second aspect of the invention can be favorably manufactured by adhering a side of the layer (20) consisting of the fluorine resin of the laminate film formed by co-extrusion having the layer (20) consisting of the fluorine resin and the delaminatable resin layer (60) to the transparent resin layer (80) consisting of the polyester series resin, and by adhering the transparent resin layer (80) consisting of the polyester series resin to the non-elongated layer (50) consisting of the polyester series resin.

In the first and second aspects of the invention, the delaminatable resin layer (60) consists of a polyethylene resin.

In the first and second aspects of the invention, the layer (20) consisting of the fluorine resin consists of an ethylene-tetrafluoroethylene copolymer.

In the first and second aspects of the invention, at a time of film making, styrene equivalent weight-average molecular weight of the polyester series resin by gel permeation chromatography (GPC) is preferably in the range of 65000-140000.

In the first and second aspects of the invention, a resin forming the non-elongated layer (50) consisting of the polyester series resin preferably includes a crystalline polybutylene terephthalate series resin, and preferably indicates a clear endothermic peak attributing to crystal melting at the first heating-up time measured by differential scanning calorimetry in accordance with JIS (Japanese Industrial Standard)-K7121 with a rate of heating-up temperature 10° C./min, and the crystal melting calorie (ΔHm (J/g)) is preferably 1060.

The third aspect of the present invention is a resin coated metal sheet in which the laminate film for coating metal sheet of the first and second aspects of the present invention is adhered.

The fourth aspect of the present invention is a laminate film comprising: a base resin layer (30); an embossable layer (40) thereon; and a layer (20) consisting of a fluorine resin on top thereof.

The fourth aspect of the invention is suitably used for a laminate film for screen board, which is a laminate film for coating metal sheet to be used by laminating on a metal surface.

In the fourth aspect of the invention, wherein an opposite surface of the layer (20) consisting of the fluorine resin to another surface thereof on which the embossable layer (40) is laminated preferably has a delaminatable resin layer (60).

The laminate film for coating metal sheet for screen board according to the fourth aspect of the invention is preferably manufactured by adhering a side of the layer (20) consisting of the fluorine resin of the laminate film laminated by co-extrusion having the layer (20) consisting of the fluorine resin and the delaminatable resin layer (60) to a side of the embossable layer (40) of the laminate film laminated by co-extrusion having the embossable layer (40) and the base resin layer (30).

The fifth aspect of the present invention is a laminate film for coating metal sheet for screen board which is used for laminating on a metal surface, comprising: a base resin layer (30); an embossable layer (40) thereon; further a layer (90) consisting of a tetrafluoroethylene-hexafluoropropylene-vinylidene fluoride copolymer thereon; and a layer (20) consisting of a fluorine resin on top thereof.

In the fifth aspect of the invention, an opposite surface of the layer (20) consisting of the fluorine resin to another surface thereof on which the layer (90) consisting of a tetrafluoroethylene-hexafluoropropylene-vinylidene fluoride copolymer is laminated preferably has a delaminatable resin layer (60).

The laminate film according to the fifth aspect of the invention can be preferably manufactured such that a side of the layer (90) consisting of a tetrafluoroethylene-hexafluoropropylene-vinylidene fluoride copolymer of the laminate film laminated by co-extrusion having layer (90) consisting of a tetrafluoroethylene-hexafluoropropylene-vinylidene fluoride copolymer, the layer (20) consisting of the fluorine resin and the delaminatable resin layer (60) is adhered to a side of the embossable layer (40) of the laminate film laminated by co-extrusion having the embossable layer (40) and the base resin layer (30).

In the fourth and fifth aspects of the invention, a printing layer is preferably formed on an opposite surface of the embossable layer (40) to another surface thereof on which the base resin layer (30) is laminated.

In the fourth and fifth aspects of the invention, the delaminatable resin layer (60) consists of a polyethylene resin.

In the fourth and fifth aspects of the invention, thickness of the layer (20) consisting of the fluorine resin is 10 μm or less.

In the fourth and fifth aspects of the invention, the layer (20) consisting of the fluorine resin is preferably a layer consisting of an ethylene-tetrafluoroethylene copolymer.

The sixth aspect of the present invention is a laminate film for coating metal sheet for screen board which is used for laminating on a metal surface, comprising: a base resin layer (30); an embossable layer (40) thereon; further a layer (92) consisting of a modified polyolefin resin thereon; and a layer (25) consisting of an adhesive fluorine resin on top thereof.

In the sixth aspect of the invention, total thickness of the layer (92) consisting of the modified polyolefin resin and the layer (25) consisting of the adhesive fluorine resin is preferably 10 μm or less.

In the sixth aspect of the invention, an opposite surface of the layer (25) consisting of the adhesive fluorine resin to another surface thereof on which the layer (92) consisting of the modified polyolefin resin is laminated preferably has a layer (20) consisting of a fluorine resin.

The seventh aspect of the present invention is a laminate film for coating metal sheet for screen board which is used for laminating on a metal surface, comprising: a base resin layer (30); an embossable layer (40) thereon; a layer (92) consisting of the modified polyolefin resin thereon; further, a layer (94) consisting of an ethylene-vinyl alcohol copolymer thereon; and a layer (25) consisting of an adhesive fluorine resin on top thereof.

In the seventh aspect of the invention, total thickness of the layer (92) consisting of the modified polyolefin resin, the layer (94) consisting of the ethylene-vinyl alcohol copolymer, and the layer (25) consisting of the adhesive fluorine resin is preferably 15 μm or less.

In the seventh aspect of the invention, an opposite surface of the layer (25) consisting of the adhesive fluorine resin to another surface thereof on which the layer (94) consisting of the ethylene-vinyl alcohol copolymer is laminated preferably has a layer (20) consisting of a fluorine resin.

In the sixth and seventh aspects of the invention, the adhesive fluorine resin preferably contains carbonate group.

In the sixth and seventh aspects of the invention, the adhesive fluorine resin preferably contains maleic acid group.

In the fourth, fifth, sixth, and seventh aspects of the invention, the embossable layer (40) preferably contains 50 mass % or more of a substantially amorphous polyester series resin of which clear crystal melting peak is not observed during the heating-up time when measured by differential scanning calorimetry (DSC), to total mass of the embossable layer (40) as 100 mass %.

In the fourth, fifth, sixth, and seventh aspects of the invention, the base resin layer (30) contains 50 mass % or more of a substantially crystalline polyester series resin of which clear crystal melting peak is observed during the heating-up time when measured by differential scanning calorimetry (DSC), to total mass of the base resin layer (30) as 100 mass %.

In the fourth, fifth, sixth, and seventh aspects of the invention, if temperature of crystal melting peak (melting point) of the polyester series resin constituting of the base resin layer (30) is defined as Tm (° C.), and glass transition point of the polyester series resin constituting of the embossable layer (40) is defined as Tg (° C.), a general expression represented as follows preferably works out: Tm (° C.)>(Tg+30) (° C.).

In the fourth, fifth, sixth, and seventh aspects of the invention, styrene equivalent weight-average molecular weight measured by gel permeation chromatography (GPC) at a time of film-making of the polyester series resin forming the base resin layer (30) and the embossable layer (40) is preferably in the range of 65000˜140000.

In the fourth, fifth, sixth, and seventh aspects of the laminate film for coating metal sheet for screen board of the invention, the surface of the laminate film is preferably embossed so as to have the roughness thereof in the following range: Ra (center-line mean deviation of the profile) 0.7 μm or more and 5 μm or less; Ry (maximum height of the profile) 4 μm or more and 40 μm or less; Rz (ten-point height of irregularities) 3 μm or more and 30 μm or less; Rp (average depth profile) 1.5 μm or more and 20 μm or less; and Pc (peak count) 7 or more and 50 or less, and gloss of the surface is defined as 50 or less.

In this description, the above “Ra”, “Ry”, “Rz”, “Rp”, and “Pc” are measured in accordance with JIS B 0661-1994. Specifically, by using high-accuracy microshape measuring machine ET4000AK (manufactured by Kosaka Laboratory Ltd.), these are measured based on the standard length as 8 mm. While, “gloss” is a specular gloss of incident angle 60° measured in accordance with JIS K 7105.

The laminate film for coating metal sheet for screen board according to sixth and seventh aspects of the invention is preferably manufactured by forming the individual laminate film by co-extrusion and giving emboss patterns thereon by emboss roll.

The eighth aspect of the present invention is a laminate film coated metal sheet for screen board comprising: the laminate film for coating metal sheet for screen board according to fourth, fifth, sixth, and seventh aspects of the invention; and a metal sheet (10) adhered to the side of the base resin layer (30) of the laminate film.

The laminate film for coating metal sheet for screen board of the fourth, fifth, sixth, and seventh aspects of the invention can be adhered to a wooden board so as to make a designed wooden board. Also, the laminate film can be adhered to a plastic board so as to make a designed plastic board. Since it is capable to adhere the laminate film on the wooden board and the plastic board at room temperature, there is an advantage of prevention of the emboss reversion when the film is adhered.

The ninth aspect of the present invention is a laminate film for coating metal sheet for screen board to laminate on a metal surface comprising: a layer (42) of which elastic modulus at 180° C.˜200° C. is 1.0×10⁷ Pa or less and elastic modulus at 120° C.˜160° C. is 1.0×10⁸ Pa or more, and a layer (20) consisting of a fluorine resin thereon.

The tenth aspect of the present invention is a laminate film for coating metal sheet for screen board to laminate on a metal surface comprising: a base resin layer (30); a layer (42) of which elastic modulus at 180° C.˜200° C. is 1.0×10⁷ Pa or less and elastic modulus at 120° C.˜160° C. is 1.0×10⁸ Pa or more thereon; and a layer (20) consisting of a fluorine resin on top thereof.

In the laminate film for coating metal sheet for screen board according to the tenth aspect of the invention, an opposite surface of the layer (20) consisting of the fluorine resin to another surface thereof on which layer (42) of the elastic modulus at 180° C.˜200° C. is 1.0×10⁷ Pa or less and elastic modulus at 120° C.˜160° C. is 1.0×10⁸ Pa or more is laminated preferably has a delaminatable resin layer. Moreover, the laminate film can be preferably manufactured such that a side of the layer (20) consisting of the fluorine resin of the laminate film laminated by co-extrusion having the delaminatable resin layer and the layer (20) consisting of the fluorine resin is adhered to a side of the layer (42) of which elastic modulus at 180° C.˜200° C. is 1.0×10⁷ Pa or less and elastic modulus at 120° C.˜160° C. is 1.0×10⁸ Pa or more of the laminate film laminated by co-extrusion having the layer (42) of which elastic modulus at 180° C.˜200° C. is 1.0×10⁷ Pa or less and elastic modulus at 120° C.˜160° C. is 1.0×10⁸ Pa or more and a base resin layer (30).

The twelfth aspect of the present invention is a laminate film for coating metal sheet for screen board to laminate on a metal surface comprising: a base resin layer (30); a layer (42) of which elastic modulus at 180° C.˜200° C. is 1.0×10⁷ Pa or less and elastic modulus at 120° C.˜160° C. is 1.0×10⁸ Pa or more thereon; further, a layer (90) consisting of a tetrafluoroethylene-hexafluoropropylene-vinylidene fluoride copolymer thereon; and a layer (20) consisting of a fluorine resin on top thereof.

The thirteenth aspect of the present invention is a laminate film for coating metal sheet for screen board to laminate on a metal surface comprising: a base resin layer (30); a layer (42) of which elastic modulus at 180° C.˜200° C. is 1.0×10⁷ Pa or less and elastic modulus at 120° C.˜160° C. is 1.0×10⁸ Pa or more thereon; further, a layer (92) consisting of a modified polyolefin resin thereon; and a layer (25) consisting of an adhesive fluorine resin on top thereof.

In the ninth to thirteenth aspects of the invention, the layer (42) of which elastic modulus at 180° C.˜200° C. is 1.0×10⁷ Pa or less and elastic modulus at 120° C.˜160° C. is 1.0×10⁸ Pa or more is preferably a layer consisting of a polycarbonate.

In the ninth, tenth, and twelfth aspects of the invention, thickness of the layer (20) consisting of the fluorine resin is preferably 10 μm or less.

In the ninth, tenth, and twelfth aspects of the invention, the layer (20) consisting of the fluorine resin is preferably a layer consisting of an ethylene-tetrafluoroethylene copolymer.

In the thirteenth aspect of the invention, the adhesive fluorine resin preferably contains carbonate group.

In the thirteenth aspect of the invention, the adhesive fluorine resin preferably contains maleic acid group.

In the ninth to thirteenth aspects of the invention, roughness of the film surface is in the following range: Ra (center-line mean deviation of the profile) 0.7 μm or more and 5 μm or less; Ry (maximum height of the profile) 4 μm or more and 40 μm or less; Rz (ten-point height of irregularities) 3 μm or more and 30 μm or less; Rp (average depth profile) 1.5 μm or more and 20 μm or less; Pc (peak count) 7 or more and 50 or less, and gloss of the film surface is defined as 50 or less.

The fourteenth aspect of the present invention is a laminate film coated metal sheet for screen board comprising: the laminate film for coating metal sheet for screen board of the ninth aspect of the invention, and a metal sheet (10) adhered to a side of the layer (42) of which elastic modulus at 180° C.˜200° C. is 1.0×10⁷ Pa or less and elastic modulus at 120° C.˜160° C. is 1.0×10⁸ Pa or more of the laminate film.

The fifteenth aspect of the present invention is a laminate film coated metal sheet for screen board comprising: the laminate film for coating metal sheet for screen board of the tenth to thirteenth aspects of the invention, and a metal sheet (10) adhered to a side of the base resin layer (42) of the laminate film.

### Effects of the Invention

According to the laminate film for coating metal sheet of the first and second aspects of the present invention, by forming the laminate film containing the layer consisting of a fluorine resin by co-extrusion and adhering this to the base film, it is capable to make the layer consisting of the fluorine resin thinner; the laminate film can be economically advantageous compared with films of the conventional art. In addition, since a delaminatable resin layer exists on the surface of the layer consisting of the fluorine resin, it is also possible to prevent the layer consisting of the fluorine resin on the surface of the resin coated metal sheet from fouling and being damaged.

The laminate film for coating metal sheet for screen board of the fourth to seventh aspects of the invention has writing-and-drawing property, erasability, and anti-glare property; it is possible to economically manurfacture the film by reducing the fluorine resin usage; and it can be efficiently manufactured by reducing the steps for laminating with adhesive.

The laminate film for coating metal sheet for screen board of the ninth to thirteenth aspects of the invention, together with the above effect of the invention, since it has a layer having a predetermined elastic modulus as an embossable layer, during the heating for adhering the film to the metal sheet after providing emboss patterns thereon, the emboss reversion in the film surface can be prevented.

### BRIEF DESCRIPTION OF THE DRAWINGS

FIGS. 1(a), 1(b), 1(c), 1(d), and 1(e) are schematic views showing the layer compositions of the laminate film for coating metal sheet and the resin coated metal sheet of the present invention;

FIGS. 2(a), 2(b), 2(c), 2(d), and 2(e) are schematic views showing the layer compositions of the laminate film for coating metal sheet for screen board and the laminate film coated metal sheet for screen board of the invention;

FIGS. 3(a), 3(b), 3(c), 3(d), 3(e), and 3(f) are schematic views showing the layer compositions of the laminate film for coating metal sheet for screen board and the laminate film coated metal sheet for screen board of the invention;

FIG. 4 is a schematic view showing the mechanism of the embossing machine; and

FIG. 5 is a graph showing the variation of elastic modulus of individual resin corresponding to the temperature.

### DESCRIPTION OF THE REFERENCE NUMERALS

100a˜100d laminate film for coating metal sheet
200a resin coated metal sheet
100e˜100p laminate film for coating metal sheet for screen board
200b, 200c laminate film coated metal sheet for screen board
10 metal sheet
20 layer consisting of a fluorine resin
25 layer consisting of an adhesive fluorine resin
30 base resin layer
40 embossable layer
42 layer of which elastic modulus at 180° C.˜200° C. is 1.0×10⁷ Pa or less, and elastic modulus 120° C.˜160° C. is 1.0×10⁸ Pa or more
50 non-elongated layer consisting of a polyester series resin
60 delaminatable resin layer
70 printing layer
80 transparent resin layer consisting of a polyester series resin
90 layer consisting of tetrafluoroethylene-hexafluoropropylene-vinylidene fluoride copolymer
92 layer consisting of a modified polyolefin resin
94 layer consisting of ethylene-vinylalcohol copolymer

### BEST MODE FOR CARRYING OUT THE INVENTION

<Laminate Film for Coating Metal Sheet>

The laminate films for coating metal sheets 100a˜100d of the present invention will be described in detail as follows, based on two embodiments by referring to the drawings.

<Laminate Film for Coating Metal Sheets 100a, 100b of the First Invention>

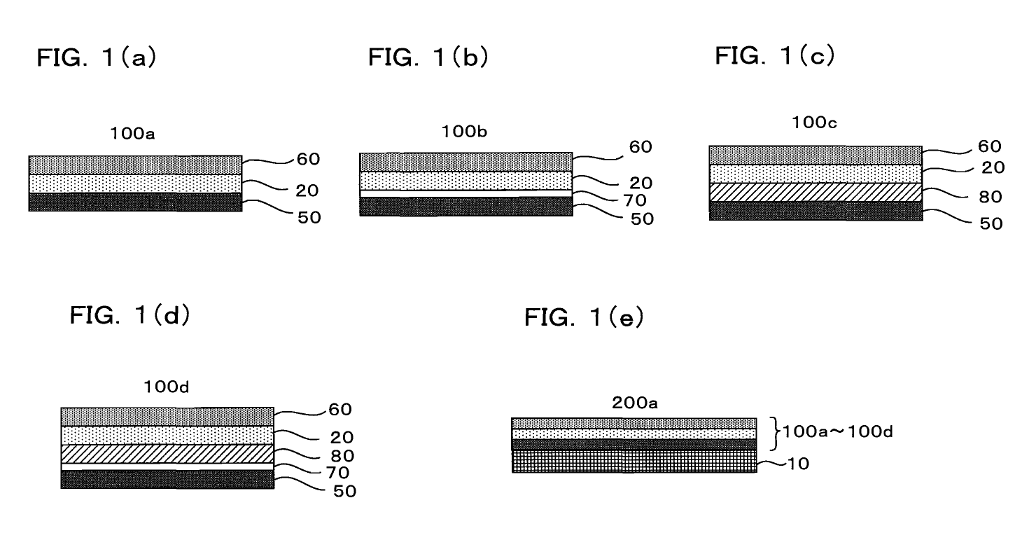

FIG. 1(a) illustrates a laminate film 100a for coating metal sheet of the first embodiment of the present invention. The laminate film 100a for coating metal sheet of the invention has a non-elongated layer 50 consisting of a polyester series resin, a layer 20 consisting of a fluorine resin, and a delaminatable resin layer 60. On an opposite surface of the non-elongated layer 50 consisting of the polyester series resin to another surface thereof on which the layer 20 consisting of the fluorine resin, a metal sheet 10 is adhered to form a resin coated metal sheet 200a.

When the resin coated metal sheet 200a is stored, the layer 20 consisting of the fluorine resin is protected in a condition that the delaminatable resin layer 60 is laminated thereon. When the resin coated metal sheet 200a is actually used, the delaminatable resin layer 60 is timely peeled so as the resin coated metal sheet to have the layer 20 consisting of the fluorine resin on the surface thereof.

(Metal Sheet 10)

As a metal sheet 10 coated by the laminate films 100a˜100d for coating metal sheet of the present invention, there may be sheet of various kinds of steel such as hot-rolled steel, cold-rolled steel, molten galvanized steel, electro galvanized steel, tinned steel, stainless steel, and so on, or aluminum sheet can be used. These may be used after normal chemical conversion treatment. Thickness of the metal sheet 10 is varied depending on the usage of resin coated metal sheet 200a, it is preferably selected in the range of 0.1˜10 mm.

(Layer 20 Consisting of the Fluorine Resin)

The layer 20 consisting of the fluorine resin is a layer containing the fluorine resin as the main component. Here, “containing the fluorine resin as the main component” means that the layer 20 contains, to total mass of the layer (100 mass %), 50 mass % or more of the fluorine resin, preferably 70 mass % or more, more preferably 90 mass % or more, and other substances may be suitably contained as the rest of the component. As the other substances, for example, polyolefin series resin, acrylic series resin, and the like may be used (hereinafter, the wording “containing as the main component” means the same in this description).

As a component of the layer 20 consisting of the fluorine resin, to the degree that does not damage its nature, various additives may be adequately added. Examples of the additives include additives generally used for resin material, i.e. various kinds of antioxidant such as phosphorus series and phenol series antioxidants; heat stabilizer, ultraviolet absorber, light stabilizer, nucleating agent, metal deactivator, deactivator of residual polymerization catalyst, nucleation agent, antibacterial-agent/fungicide, antistatic agent, lubricant, flame retardant, filler, and so on.

The fluorine resin is not particularly limited; any kind of fluorine resins can be used. Representative examples include ethylene-tetrafluoroethylene copolymer (ETFE), poly vinylidene fluoride-polyvinylidene fluoroethylene copolymer (PVdF), fluorinated ethylene propylene-tetrafluoroethylene-hexafluoropropylene copolymer (FEP), tetrafluoroethylene-hexafluoropropylene-vinylidene fluoride copolymer (THV), and so on, and the copolymers or mixtures thereof. Among them, ethylene-tetrafluoroethylene copolymer (ETFE), in view of antifouling property, mechanical property, workability, and the like, is preferable. The ethylene-tetrafluoroethylene copolymer (ETFE) can be easily obtained in the market. The examples may be Aflon COP (manufactured by Asahi Glass Co., Ltd.), Tefzel (manufactured by Du Pont), Neoflon ETFE (manufactured by Daikin Industries, Ltd).

Thickness of the layer 20 consisting of the fluorine resin, from the viewpoint of strength, is preferably 3 μm or more, more preferably 5 μm or more. In the laminate film for coating metal sheet of the invention, it is possible to make the layer 20 consisting of the fluorine resin thinner by co-extrusion forming. Thickness of the layer 20 consisting of the fluorine resin is preferably 10 μm or less, more preferably 7 μm or less.

In the resin coated metal sheet 200a of the present invention, the delaminatable resin layer 60 is peeled when the sheet is used. At this phase, the layer 20 consisting of the fluorine resin is the outermost layer of the resin coated metal sheet 200, it gives antifouling property to the resin coated metal sheet 200 of the invention.

(Non-Elongated Layer 50 Consisting of the Polyester Series Resin)

The non-elongated layer 50 consisting of the polyester series resin is a layer consisting of polyester series resin as the main component. As a component of the non-elongated layer 50 consisting of the polyester series resin, to the degree which does not damage its nature, various additives may be adequately added. Examples of additives may be the above-mentioned additives which can be added for the layer 20 consisting of the fluorine resin.

The polyester series resin is not particularly limited; various kinds thereof can be used. Representative examples include polymers consisting of: one or more alcohollic component selected from a group consisting of ethylene glycol, propylene glycol, butane diol, cyclohexane dimethanol, and so on; and one or more acid component selected from a group consisting of terephthalic acid, isophthalic acid, adipic acid, and so on; or mixture of these polymers.

At a time of film making, styrene equivalent weight-average molecular weight of the polyester series resin measured by gel permeation chromatography (GPC) is preferably in the range of 65000˜140000, more preferably in the range of 75000˜120000.

If the molecular weight is too low, as described below, endurance of the resin coated metal sheet when used in the wet-hot environment is not sufficient, therefore it is not preferable. While, if the molecular weight is too high, raw material of higher molecular weight is further required. Such a raw material of higher molecular weight cannot be usually and continuously obtained, therefore usage of the raw material of higher molecular weight is costly and not preferable. Even if such a raw material can be obtained, when the sheet is coated, effect for improving the endurance of the sheet is saturated, but also necessary energy for film-coating becomes larger. Hence, it is not preferable.

In general, the main reason for deterioration of a polyester series resin when used in the wet-hot environment is considered to be hydrolysis. If the hydrolysis progresses, the film is deteriorated and mechanical strength of the film declines; thereby the film may be broken up when it is bent. When the film is used in the resin coated metal sheet, cracks occur in the film layer or the film layer is peeled. These phenomena damage the design of exterior, at the same time, anticorrosive effect on the metal surface by the film cannot be obtained.

The deterioration of resin by hydrolysis is caused in a part of ester bonding in the polyester chains, and this lowers the molecular weight of the resin. Moreover, decline of mechanical strength such as broken-up of the film is significantly caused when the molecular weight drops below a certain value. If a molecular weight of the resin is already low at a phase of film-coating, the molecular weight drops below a certain value because of the use of the film under a wet-hot environment for a short period of time; mechanical strength thereof is decreased. On the other hand, if molecular weight is high at a phase of film coating, even if the film is used under a wet-hot environment, it takes long time before mechanical strength of the resin declines. Thus, if the film is used under a wet-hot environment, molecular weight declines due to hydrolysis; however, if the molecular weight at a phase of film-coating is higher, molecular weight is high even after certain period of time. It is understood that mechanical strength of the resin is preserved. Therefore, so as the non-elongated layer consisting of a polyester series resin to be a film-coated sheet having favorable humidity-heat resistance, a polyester series resin of which molecular weight is high to the certain extent need to be used.

In order to prevent decline of molecular weight of the polyester series resin, following measures are considered.

The measures for film-coating apparatus are as follows:

(1) optimizing the screw design for prevention of decline of the molecular weight;
(2) installing bent apparatus at appropriate positions to lower the hydrolysis at the phase of film-coating;
(3) detention period must not be too long more than necessary; and
(4) reducing effect of absorbed water by devising ways of drying the raw material.

The measures for blending the non-elongated layer consisting of the polyester series resin:

(1) a coloring pigment having thermal-catalytic action or hydrolysis stimulatory effect should not be used;
(2) catalytic activity should be inactivated when the coloring pigment having thermal-catalytic action or hydrolysis stimulatory effect is used;
(3) inhibiting the polyester molecule to be cut down automatically in the forming machine by adding lubricants;
(4) inhibiting pyretic action due to shearing by adding lubricants; and
(5) adding hydrolysis inhibitor.

As the polyester series resin of the present invention, a polyester series resin in which crystalline polybutylene terephthalate series resin (hereinafter, it may be referred as “PBT”.) is blended can be suitably used.

The reason for this is as follows:

(1) comparatively high grade of initial molecular weight is lineupped as the extrusion grades;
(2) hydrolysis reaction rate of the polyester series resin should be smaller than that of a polyethylene terephthalate series resin (refer to “heat and hydrolysis characteristics of poly (1,4-butylene terephthalate)”, Journal of the Society of Fiber Science and Technology, Japan, Vol. 43, No. 7 (1987), by TANAKA, Michihiko of Toray Fibers and Textiles Research Laboratories);
(3) although the polyester series resin is a crystalline resin of which elastic modulus of the polyester series resin in the crystalline region is smaller than that of polyethylene terephthalate series resin and of which flexibility in the crystallized part is high, the resin exhibits excellent workability when coated over the metal sheet at a condition in which the crystal characteristics is comparatively high;
(4) melting point (Tm) is nearly the same temperature as or slightly lower temperature than surface temperature of the metal sheet when laminated by a conventional flexible PVC sheet, the apparatus used for laminating the flexible PVC sheet can be used as it is; and etc.

As the crystalline polybutylene terephthalate series resin, the so-called “homo-polybutylene terephthalate”, in which terephthalic acid as the acid component and 1,4-butane diol as the alcohollic component are only used, can be suitably used. Further, if surface temperature of the metal sheet when laminated is required to be further lowered, a polybutylene terephthalate of which part of the acid component is substituted by an isophthalic acid can be used.

The blending ratio is preferably (20˜80):(80˜20) (“crystalline polybutylene terephthalate series resin”: “amorphous or low-crystalline polyester series resin”), in view of realizing the following advantage.

The advantage of blending is: compared with the case using the crystalline polybutylene terephthalate series resin only, the blended resin having such as amorphous polyester series resin can lower the crystal melting calorie (ΔHm). Thereby, it is capable to obtain a strong adhesiveness even though surface temperature of the metal sheet before lamination is set to comparatively low. Further, by blending amorphous or low-crystalline polyester series resin, it is capable to adequately slow the crystallization rate and to raise glass transition temperature (Tg). Accordingly, it is possible to obtain a sheet of low-crystal characteristics at a time of film-coating by extrusion, and therefore possible to laminate at a lower temperature than melting point of the crystalline polybutylene terephthalate series resin.

When a blended resin having a crystalline polybutylene terephthalate series resin and an amorphous or a low-crystalline polyester series resin is used as a polyester series resin, the resin forming the non-elongated layer consisting of the polyester series resin indicates a clear endothermic peak attributing to crystal melting at the first heating-up time measured by differential scanning calorimetry in accordance with JIS-K7121 with a rate of heating-up temperature 10° C./min, and the crystal melting calorie (ΔHm (J/g)) is preferably 10˜60.

The differential scanning calorimetry, precisely, by using Parkin-Elmer's DSC-7, in accordance with JIS-K7121 “Testing methods for transition temperatures of plastics and methods for calculating the melting point”, crystal melting calorie of test sample 10 mg at the first heating-up time is measured with a rate of heating-up temperature 10° C./min.

When the crystal melting calorie is too small, blending ratio of the amorphous resin or low-crystalline resin becomes high, it becomes difficult to pass the boiling water resistance test. While, the polyester series resin, of which crystal melting calorie is too large, is difficult to obtain.

The wording “clear” of the endothermic peak attributing to the crystal melting means that the peak is the one which attributing to 10 J/g or more of crystal melting.

As an amorphous or low-crystalline polyester series resin for blending to the crystalline polybutylene terephthalate series resin, “Easter 6763” manufactured by Eastman Chemical Company which is manufactured at low-cost because of the stable supply of the raw material and large quantity of production thereof, or similar resin thereto can be preferably used. However, the amorphous or low-crystalline polyester series resin is not limited to this. For example, a neopentyl glycol copolymer PET which does not exhibit crystal characteristics, or a neopentyl glycol copolymer PET which does exhibit its melting point at a special cooling condition such as “PCTG 5445” (manufactured by Eastman Chemical Company), which is generally capable to treat as an amorphous resin, may be used.

By using additives, decline of the molecular weight at a phase of coating polyester series resin is inhibited, and it is capable to obtain a polyester series resin having a molecular weight within the range of the present invention. As such additives, carbodiimide compounds may be the example. The carbodiimide compounds, in the forming machine at a time of extrusion coating, can inhibit hydrolysis of the polyester series resin. As a result, a non-elongated layer 50a consisting of the polyester series resin having a molecular weight described in the claims of the present invention can be easily obtained. An example of carbodiimide compounds may be one having a base structure represented by the following general formula.

—(N═C═N—R—)ₙ—

(In the above formula, n is integer of one or more. R is any one of hydrocarbon group, aliphatic group, acyclic group, and aromatic group.)

Specific examples of carbodiimide compounds include poly(4,4′-diphenyl methane carbodiimide), poly(p-phenylene carbodiimide), poly(m-phenylene carbodiimide), poly(tolyl carbodiimide), poly(diisopropylphenylene carbodiimide), poly(methyl-diisopropylphenylene carbodiimide), poly(triisopropylphenylene carbodiimide), and so on, and monomers thereof. The carbodiimide compounds may be used alone or in combination of two or more thereof.

To the polyester series resin as 100 parts by mass, 0.1-5.0 parts by mass of carbodiimide compounds is preferably added. When the additive amount is too small, the effect in improving hydrolysis resistant is not sufficient, therefore it is not preferable. On the other hand, when the additive amount is too large, the effect for inhibiting the declining molecular weight of the resins is saturated, concurrently with the cause of various problems in extrusion coat-making. Moreover, with respect to the film-coated sheet, defective appearance and decline of mechanical property of carbodiimide compounds may be easily caused by breeding-out phenomenon; thus it is not preferable. Further, blending cost of the non-elongated layer 50a consisting of the polyester series resin becomes expensive, thereby it is not preferable.

Examples of the additives inhibiting hydrolysis may be block copolymer or grafted copolymer either of which has multifunctional epoxy groups. These additives can be adequately added in the range which does not undermine the nature (e.g. surface hardness, flexibility) other than humidity-heat resistance that the polyester series resin requires. With the addition of these additives, obviously, hydrolysis inhibiting property of the polyester series resin is improved.

To non-elongated layer 50 consisting of polyester series resin, pigments are preferably added. The purpose for adding pigments to it is to hide the metal sheet 10 as a base sheet and to give design to it. The pigments to be added to the non-elongated layer 50 consisting of the polyester series resin need to be the one which does act as a polymerization catalyst of polyester series resin as less as possible. For white type coloring, oxide titanium pigment is necessarily used, this oxide titanium pigment needs to be a rutile type oxide titanium of which surface is sufficiently finished. While, an anatase type oxide titanium tends to cause peeling of the surface finish; therefore it is not preferable.

When the metal sheet is colored with oxide titanium series pigment and is colored in chromatic color by adding coloring pigment, a pigment which facilitates deterioration of the polyester series resin (like decrease of the molecular weight) should not used. If pigments facilitating deterioration of this polyester series resin is necessarily used, it is preferable to add carbodiimide compounds.

Thickness of the non-elongated layer 50 consisting of the polyester series resin, in view of film's workability, mechanical property and so on, is preferably 50˜300 μm, more preferably 100˜200 μm.

Further, the non-elongated layer 50 consisting of the polyester series resin acts for giving film rigidity to the laminate film. Because of this, workability for adhering the laminate film 100a˜100d of the present invention to the metal sheet 10 is improved.

(Delaminatable Resin Layer 60)

The delaminatable resin layer 60 is a layer laminated on the layer 20 consisting of the fluorine resin and having a role of protecting the surface of the layer 20 consisting of the fluorine resin. For example, when the resin coated metal sheet 200 coated by the laminate film for coating metal sheet 100a˜100d of the invention is stored or transported, the delaminatable resin layer 60 is left as it is, so as to protect the layer 20 consisting of the fluorine resin. When the sheet is actually used, by peeling the delaminatable resin layer 60, it is capable to obtain the resin coated metal sheet 200 having no dirt and damage on the surface. The delaminatable resin layer 60 is co-extruded with the layer 20 consisting of the fluorine resin to make the laminate film.

The wording “delaminatable” means that the delaminatable resin layer 60 can be easily peeled from the layer 20 consisting of the fluorine resin without leaving any remain of the delaminatable resin layer 60 on the surface of the layer 20 consisting of the fluorine resin (peeled surface).

The resin forming the delaminatable resin layer 60 is not particularly limited as long as it can form the laminate film by co-extrusion with the fluorine resin; various kinds thereof can be used. For instance, as the delaminatable resin layer 60, a film mainly containing polyethylene resin, polypropylene resin, and polystyrene resin, or a polyethylene terephthalate film coated by an ethylene-vinyl acetate copolymer (hereinafter, it may be omitted as “EVA coated PET film”.) may be used. Among them, in view of film's workability, mechanical property and so on, it is preferable to use polyethylene resin and EVA coated PET film. Vice versa, laminating the fluorine resin by co-extrusion to the delaminatable resin layer 60 is possible to form the laminate film. When EVA coated PET film is used as the delaminatable resin layer 60, specifically, the laminate film is preferably made by co-extrusion. The EVA coated PET film is a film which exhibits excellent thickness accuracy and stiffness. Therefore, when the fluorine resin is co-extruded over the EVA coated PET film, the EVA coated PET film is capable to excellently adjust the thickness accuracy of the fluorine resin layer. The EVA coated PET film exhibits excellent stiffness and easy handling. Hence, workability of co-extrusion of the fluorine resin over the EVA coated PET film becomes favorable; and handling of the obtained laminate film becomes easier.

To the delaminatable resin layer 60, various additives may be adequately added in the range which does not undermine the nature. As an additive, the above additives which can be added to the layer 20 consisting of the fluorine resin may be used.

Thickness of the delaminatable resin layer 60, in view of film's mechanical property, workability in co-extrusion with the layer 20 consisting of the fluorine resin, film rigidity of the laminate film, and so on, is preferably in the range of 5˜100 μm, more preferably in the range of 10˜50 μm.

(Method for Manufacturing a Laminate Film for Coating Metal Sheet of the First Invention)

The delaminatable resin layer 60 and the layer 20 consisting of the fluorine resin are co-extruded so as to make the laminate film. In the co-extrusion forming, two extruding machines, which are compatible with both a resin forming the delaminatable resin layer 60 and a fluorine resin, are used. These two kinds of resin materials are fed into integrally coupled extrusion-dies and the fed resins are contacted at an inner part or opening of the dies so as to make the laminate film as a single extrusion product.

In the laminate film, even if the layer 20 consisting of the fluorine resin is made thinner, since the delaminatable resin layer 60 gives film rigidity to the laminate film, it makes the dry-lamination for adhering this laminate film to the non-elongated layer 50 consisting of the polyester series resin easier. By making the thickness of the layer 20 consisting of the fluorine resin thinner, the laminate film 100a for coating metal sheet of the present invention can be economical.

To an opposite surface of the layer 20 consisting of the fluorine resin to another surface thereof on which the delaminatable resin layer 60 is laminated, the non-elongated layer 50 consisting of the polyester series resin is adhered through adhesive by dry-lamination. This is how the laminate film 100a for coating metal sheet is made.

The adhesive to be used for dry-lamination is not particularly limited; any kinds of adhesives such as polyester series, epoxy series, acrylic series, urethane series can be used. Specifically, as a polyester series thermoset adhesive, blended adhesive having 100 parts by mass of “Takerack A310” and 5 parts by mass of “Takenate A3” (both manufactured by Mitsui Takeda Chemicals, Inc.) may be used.

By giving surface treatment or undercoating on the surface of non-elongated layer 50 consisting of the polyester series resin and/or the layer 20 consisting of the fluorine resin, adhesiveness with the adhesives is improved, and durability and so on also improved. Therefore, it is more preferable to give these treatments. As a surface treatment, for example, there may be corona discharge treatment.

To an opposite surface of the non-elongated layer 50 consisting of polyester series resin of the laminate film 100 to another surface thereof on which the layer 20 consisting of the fluorine resin is laminated, the metal sheet 10 is adhered. Methods for adhering the above opposite surface to the metal sheet 10 may be extrusion-lamination, heat-sealing, or a method using an art for laminating conventional PVC steel sheet by use of adhesives such as polyester series, epoxy series, acrylic series, urethane series adhesives.

(Printing Layer 70)

As seen from the embodiment shown in FIG. 1(b), in the present invention, to the resin coated metal sheet 100a, in order to give beauty and the like, a printing layer 70 is preferably placed at the side of the non-elongated layer 50 consisting of the polyester series resin between the non-elongated layer 50 consisting of the polyester series resin and the layer 20 consisting of the fluorine resin.

The printing layer 70 is given in accordance with the methods publicly known such as gravure printing, offset printing, and screen printing. This is for the purpose of giving printing design like stonegrain pattern, woodgrain pattern, or geometric pattern, and abstract pattern. It may be partial printing or over-all printing, even both of partial printing layer and over-all printing layer may be provided.

<Laminate Film for Coating Metal Sheets 100c, 100d of the Second Invention>

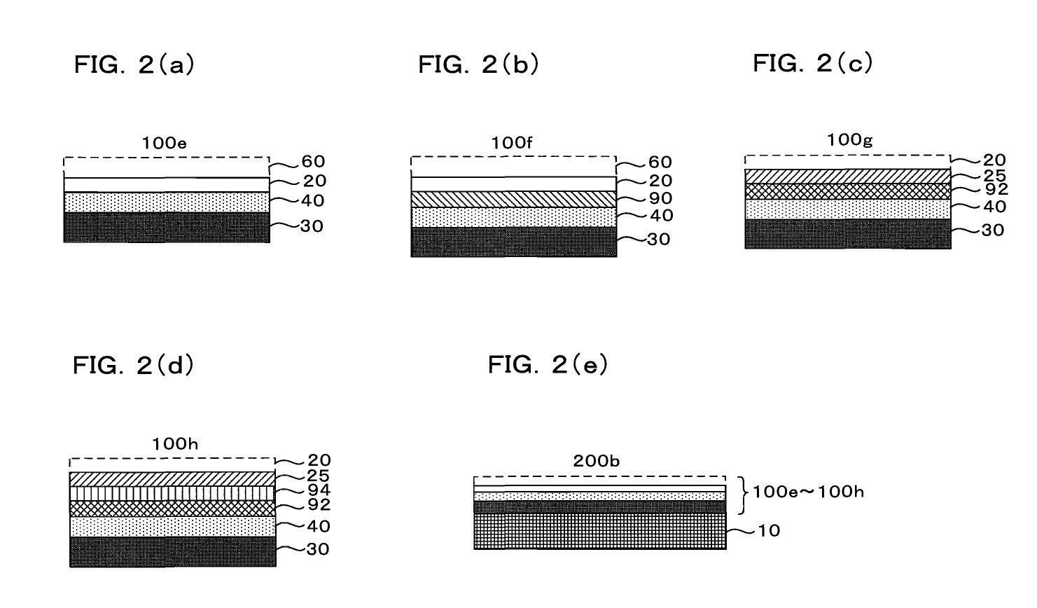

FIGS. 2(c) and 2(d) show laminate film for coating metal sheets 100c and 100d of the second invention. The laminate film for coating metal sheet 100c of the present invention has a non-elongated layer 50 consisting of a polyester series resin, a transparent resin layer 80 consisting of a polyester series resin thereon, further, a layer 20 consisting of a fluorine resin thereon, and a delaminatable resin layer 60 on top thereof. To an opposing surface of the non-elongated layer 50 consisting of the polyester series resin to another surface thereof on which the transparent resin layer 80 consisting of the polyester series resin is laminated, a metal sheet 10 is adhered to form the resin coated metal sheet 200.

The non-elongated layer 50 consisting of the polyester series resin, the layer 20 consisting of the fluorine resin, and the delaminatable resin layer 60 are the same as used in the laminate film for coating metal sheet according to the first embodiment of the present invention.

Layer thickness of the non-elongated layer 50 consisting of the polyester series resin of the laminate film for coating metal sheets 100c, 100d of the second invention, in view of workability at a time of adhering the laminate film to the metal sheet and in view of coat-making, is preferably 25˜300 μm, more preferably 50˜150 μm.

(Transparent Resin Layer 80 Consisting of a Polyester Series Resin)

Transparent resin layer 80 consisting of a polyester series resin is a layer consisting of the polyester series resin as the main component. To the transparent resin layer 80 consisting of the polyester resin, various kinds of additives may be adequately added in the range which does not undermine the nature thereof. As the additives, same additives as the above-mentioned additives which can be added to the layer 20 consisting of the fluorine resin may be used.

As the polyester series resin in the transparent resin layer 80, same one as the polyester series resin of the above-described non-elongated layer 50 consisting of polyester series resin may be used. The transparent resin layer 80 consisting of the polyester series resin is preferably a transparent elongated layer consisting of the polyester series resin or a transparent non-elongated layer consisting of polyester series resin.

The transparent elongated layer 80 consisting of the polyester series resin is not particularly limited; it may be a material used for protection of the printing layer, giving artistic design, and improvement of various properties of the surface. Among them, from the viewpoint of transparency, smoothness, damage resistance of the surface, and so on, biaxially-stretched polyester series resin, specifically, a polyethylene terephthalate series resin film may be preferably used.

Thickness of the transparent resin layer 80 consisting of the polyester series resin, in view of workability at a phase of adhering the laminate film to the metal sheet 10 and film-coating, is preferably 15˜75 μm, more preferably 25˜50 μm. In addition, for the transparent resin layer 80, a film of which elongation magnification is about 3.5˜4 times each in biaxial direction; of which heat-fixation temperature after elongation is about 220° C.˜240° C.; and which has been generally used for overlay of flexible to a PVC sheet may be used.

(Method for Manufacturing Laminate Film for Coating Metal Sheets 100c, 100d of the Second Invention)

The delaminatable resin layer 60 and the layer 20 consisting of the fluorine resin, as shown in the first embodiment of the invention, is co-extruded to make the laminate film. Also shown in the first embodiment of the invention, the laminate film can be made by laminating the fluorine resin to the delaminatable resin layer 60 by extrusion-lamination. Specifically, if the delaminatable resin layer 60 is the EVA coated PET film, it is preferable to make the laminate film by extrusion-lamination. To an opposing surface of the layer 20 consisting of the fluorine resin to another surface thereof on which the delaminatable resin layer is laminated, the transparent resin layer 80 consisting of the polyester series resin is adhered by dry-lamination through adhesives. And, to an opposing surface of the transparent resin layer 80 consisting of a polyester series resin to another surface thereof on which the layer 20 consisting of the fluorine resin is laminated, the non-elongated layer 50 consisting of polyester series resin is laminated by dry-lamination through adhesives. Accordingly, the laminate film for coating metal sheet 100c of the invention can be made.

Adhesives for the use of dry-lamination is not particularly limited, various kinds of adhesives may be used. Representative examples thereof may be polyester series, epoxy series, acrylic series, and urethane series adhesives.

To the surface of individual layers, i.e. the layer 20 consisting of the fluorine resin, the non-elongated layer 50 consisting of the polyester series resin, and the transparent resin layer 80 consisting of the polyester series resin adhered by dry-lamination, as described in the first embodiment, surface treatment and undercoating may be given.

To an opposing surface of the non-elongated layer 50 consisting of polyester series resin of the laminate film 100c to another surface thereof on which the transparent resin layer 80 consisting of the polyester series resin is laminated, the metal sheet 10 is adhered through adhesives. The adhesives may be applied on the side of non-elongated layer 50 consisting of the polyester series resin or on the metal sheet 10. In this way, the resin coated metal sheet 200 can be made. The adhesives may be the same as the one used in the first embodiment.

When the laminate film 100c is stored, the delaminatable resin layer 60 is laminated on the surface of the layer 20 consisting of the fluorine resin. The delaminatable resin layer 60 is for protecting the layer 20 consisting of the fluorine resin from fouling and damages. When the resin coated metal sheet 200 is used, this delaminatable resin layer 60 is removed.

As seen from the embodiment shown in FIG. 2(d), in the present invention, in order to give beauty to the resin coated metal sheet, the printing layer 70 is preferably provided at either of the side of non-elongated layer 50 consisting of the polyester series resin or the side of transparent resin layer 80 consisting of the polyester resin, or at both sides thereof, between the non-elongated layer 50 consisting of the polyester series resin and the transparent resin layer 80 consisting of the polyester resin.

(Printing Layer 70)

A printing layer 70 is the same as the one described in the first embodiment of the present invention. The printing layer 70, and the non-elongated layer 50 consisting of the polyester series resin or the transparent resin layer 80 consisting of the polyester series resin can be adhered by dry-lamination. When the printing layer 70 is formed on a side of both layers, two of the printing layers 70 can be adhered each other by dry-lamination.

<Laminate Film for Coating Metal Sheet for Screen Board>

The laminate film for coating metal sheet for screen board of the present invention will be described by dividing into plural embodiments, with reference to the individual drawings.

<Laminate Film 100e for Coating Metal Sheet for Screen Board of the Fourth Invention>

In FIG. 2(a), a layer structure of a laminate film for coating metal sheet for screen board 100e of the fourth invention is schematically shown. The laminate film 100e for coating metal sheet for screen board has a structure in which a base resin layer 30, an embossable layer 40, and a layer 20 consisting of a fluorine resin are laminated in this order.

(Base Resin Layer 30)

The base resin layer 30 is a non-elongated layer containing the polyester series resin as the main component. The wording “non-elongated” means that any elongation is not given to the subject layer on purpose, for example, it does not mean the lack of existence of orientation and the like produced by winding by use of casting-roll at a time of extrusion film-making. Also, the wording “as the main component” means that the component itself is contained at the ratio of 50 mass % or more, preferably 70 mass % or more, more preferably 90 mass % or more, to the entire layer only containing the component (100 mass %) (hereinafter, it means the same in this description.). While, about the base resin layer 30, when the laminate film is heated by the embossing machine, if the laminate film is constituted only of the embossable layer 40, the film is adhered to the heating rolls or is broken because of the melting. However, as the base resin layer 30 exists on the embossable layer 40, it can inhibit these problems.

The polyester series resin is not particularly limited, various kinds thereof can be used. Representative examples include polymers consisting of: one or more alcohollic component selected from a group consisting of ethylene glycol, propylene glycol, butane diol, cyclohexane dimethanol, and so on; and one or more acid component selected from a group consisting of terephthalic acid, isophthalic acid, adipic acid, and so on; or mixture of these polymers.

The base resin layer 10 preferably contains 50 mass % or more, more preferably 60 mass % or more, of a substantially crystalline polyester series resin of which clear crystal melting peak is observed during the heating-up time when measured by differential scanning calorimetry (DSC), to total mass of the base resin layer 10 as 100 mass %. By having such a layer as the base resin layer 10, when embossing the laminate film for coating metal sheet for screen board of the invention, it is possible to inhibit the adhesiveness with the heating rolls of the embossing machine and breakage of the film due to the melting.

As the substantially crystalline polyester series resin, crystalline polybutylene terephthalate series resin (hereinafter, it may be omitted as “PBT”.) may be used. As an example of crystalline polybutylene terephthalate series resin, the so-called homo-polybutylene terephthalate only having terephthalic acid as the acid component and 1,4-butane diol as the alcoholic component can be suitably used. In addition, when laminating the metal sheet 10, so as the polybutylene terephthalate to adhere to the metal sheet 10 of which surface temperature is lower, the polybutylene terephthalate in which part of the acid component is substituted by isophthalic acid may be used.

(Embossable Layer 40)

The embossable layer 40 is a non-elongated layer consisting of the polyester series resin as the main component. The embossable layer 20 preferably contains 50 mass % or more, more preferably 60 mass % or more, of a substantially amorphous polyester series resin of which clear crystal melting peak is not observed during the heating-up time when measured by differential scanning calorimetry (DSC), to total mass of the embossable layer 20 as 100 mass %.

As the substantially amorphous polyester series resin, amorphous or low-crystalline polyester series resin can be used. Specifically, “Easter 6763” (manufactured by Eastman Chemical Company) which is manufactured at low-cost because of the stable supply of the raw material and large quantity of production thereof, or similar resin thereto can be preferably used. However, the amorphous or low-crystalline polyester series resin is not limited to this. For example, a neopentyl glycol copolymer PET which does not exhibit crystal characteristics, or a neopentyl glycol copolymer PET which does exhibit its melting point at a special cooling condition such as “PCTG 5445” (manufactured by Eastman Chemical Company), which is generally capable to treat as an amorphous resin, may be used.

Styrene equivalent weight-average molecular weight measured by gel permeation chromatography (GPC) at a time of film-making of the polyester series resin forming the base resin layer 10 and the embossable layer 20 is preferably in the range of 65000˜140000, more preferably in the range of 75000˜120000.

When the molecular weight is too low, durability of the laminate film coated metal sheet 200 is inferior. While, when the molecular weight is too high, effect for improving the endurance of the sheet is saturated at the phase of film-coating, but also necessary energy for film-coating becomes larger.

The embossable layer 40 preferably contains 50 mass % or more of a substantially amorphous polyester series resin of which clear crystal melting peak is not observed during the heating-up time when measured by differential scanning calorimetry (DSC), to total mass of the embossable layer 40 as 100 mass %.

Further, if temperature of crystal melting peak (melting point) of the polyester series resin constituting of the base resin layer 30 is defined as Tm (° C.), and glass transition point of the polyester series resin constituting of the embossable layer 40 is defined as Tg (° C.), a general expression is represented as follows: Tm (° C.)>(Tg+30) (° C.).

The wording “clear” of the endothermic peak attributing to the crystal melting means that the peak is the one which attributing to 10J/g or more of crystal melting.

(Layer 20 Consisting of the Fluorine Resin)

The layer 20 consisting of the fluorine resin may be the same one which is described in the above laminate film for coating metal sheets 100a-100c.

<Laminate Film 100f for Coating Metal Sheet for Screen Board of the Fifth Invention>

FIG. 2(b) schematically shows the layer constitution of the laminate film 100f for coating metal sheet for screen board of the fifth invention. The laminate film for coating metal sheet for screen board 100f comprises a base resin layer 30, an embossable layer 40, a layer 90 consisting of tetrafluoroethylene-hexafluoropropylene-vinylidene fluoride copolymer (hereinafter, it may be omitted as “THV”.), and a layer 20 consisting of a fluorine resin; and these layers are laminated in this order. The base resin layer 30, the embossable layer 40, and the layer 20 consisting of the fluorine resin are the same as these of the fourth invention.

(Layer 90 Consisting of THV)

The layer 90 consisting of tetrafluoroethylene-hexafluoropropylene-vinylidene fluoride copolymer (THV) is a layer containing THV as the main component. The layer 90 consisting of THV has a role to make inter-layer adhesiveness favorable by intermediating thereof between the layer 20 consisting of fluorine resin and the embossable layer 40.

Copolymerization ratio of THV (mass ratio), in view of flexibility and adhesiveness, is preferably (30˜50):(10˜30):(30˜50) (“tetrafluoroethylene”:“hexafluoropropylene”:“vinylidene fluoride”), more preferably (35˜45):(15˜25):(35˜45) (“tetrafluoroethylene”:“hexafluoropropylene”:“vinylidene fluoride”).

Thickness of the layer 90 consisting of THV is preferably 10 μm or less, more preferably 5 μm or less. In the present invention, by forming the layer 90 consisting of THV by co-extrusion, thickness of the layer 90 consisting of THV can be thinner like this. Thereby it is capable to reduce the usage of the expensive fluorine resin. Thus, the economically efficient laminate film for coating metal sheet for screen can be made. If the layer 90 consisting of THV is too thick, giving emboss patterns may be difficult. Moreover, with regard to the strength of the layer 90 consisting of THV, thickness of the layer 90 consisting of THV is preferably 1 μm or more, more preferably 3 μm or more.

(Delaminatable Resin Layer 60)

In the fourth and fifth invention, the delaminatable resin layer 60 may be further laminated on the layer 20 consisting of the fluorine resin. In the fourth invention, to an opposing surface of the layer 20 consisting of the fluorine resin to another surface thereof on which the embossable layer 40 is laminated, the delaminatable resin layer 60 is laminated. Also, in the fifth invention, to an opposing surface of the layer 20 consisting of the fluorine resin to another surface thereof on which the layer 90 consisting of THV is laminated, the delaminatable resin layer 60 is laminated. The delaminatable resin layer 60 is same as those described in the above laminate film for coating metal sheets 100a˜100d.

(Printing Layer)

In order to give ruled pattern and the like to the laminate film coated metal sheet for screen board, to an opposing surface of the embossable layer 40 to another surface thereof on which the base resin layer 30 is laminated, a printing layer may be formed.

The printing layer is given in accordance with the methods publicly known such as gravure printing, offset printing, and screen printing. This is for the purpose of giving printing design like stonegrain pattern, woodgrain pattern, or geometric pattern, and abstract pattern. It may be partial printing or over-all printing, even both of partial printing layer and over-all printing layer may be provided.

(Method for Manufacturing Laminate Films 100e, 100f for Coating Metal Sheet for Screen Board)

In the laminate film 100e of the fourth invention, the delaminatable resin layer 60 and the layer 20 consisting of the fluorine resin are made into a laminate film by co-extrusion. In the co-extrusion forming, two extruding machines which are compatible with both a resin forming the delaminatable resin layer 60 and a resin forming the layer 20 consisting of the fluorine resin are used. These two kinds of resin materials are fed into integrally coupled extrusion-dies and the fed resins are contacted at an inner part or opening of the dies so as to make the laminate film as a single extrusion product. Moreover, in the laminate film 100f of the fifth invention, the delaminatable resin layer 60, the layer 20 consisting of the fluorine resin, and the layer 90 consisting of THV are made into a laminate film in the same way as above by using three extrusion machines.

A side of the layer 20 consisting of the fluorine resin or the layer 90 consisting of THV of the laminate film formed by the above-described co-extrusion is dry-laminated to a side of the embossable layer 40 of the laminate film consisting of the embossable layer 40 and the base resin layer 30 formed by co-extrusion, through adhesive, so as to make the laminate films 100e, 100f for coating metal sheet for screen board of the invention.

The adhesive used for the dry-lamination is not particularly limited, any kinds of adhesives can be used. Representative examples include polyester series, epoxy series, acrylic series, urethane series adhesives. Specifically, as a polyester series thermoset adhesive, blended adhesive having 100 parts by mass of “Takerack A310” and 5 parts by mass of “Takenate A3” (both manufactured by Mitsui Takeda Chemicals, Inc.) may be used.

By giving surface treatment or undercoating on the surface to be dry-laminated of the layer 20 consisting of the fluorine resin, the embossable layer 40, the base resin layer 30, and the layer 90 consisting of THV, adhesiveness with the adhesives is improved, durability and so on are also improved. As a surface treatment or an undercoating, for example, there may be corona discharge treatment or anchor coat.

When the delaminatable resin layer 60 is provided, even if the layer 20 consisting of fluorine resin and the layer 90 consisting of THV are made thinner, since the delaminatable resin layer 60 gives film rigidity to the laminate film, it is capable to easily adhere the laminate film to the embossable layer by dry-lamination. Further, by making the layer thickness of the layer 20 consisting of the fluorine resin and the layer 90 consisting of THV thinner, it is possible to make the economically efficient laminate films 100e, 100f for coating metal sheet for screen board of the invention.

<Laminate Film 100g for Coating Metal Sheet for Screen Board of the Sixth Invention>

FIG. 2(c) schematically shows a layer constitution of the laminate film 100g for coating metal sheet for screen board according to the third embodiment of the present invention. The laminate film 100g for coating metal sheet for screen board comprises a base resin layer 30, a embossable layer 40, a layer 92 consisting of a modified polyolefin resin, and a layer 25 consisting of an adhesive fluorine resin; and these layers are laminated in this order. The base resin layer 30, and the embossable layer 40 are the same as those in the fourth invention.

(Layer 25 Consisting of the Adhesive Fluorine Resin)

The layer 25 consisting of the adhesive fluorine resin is a layer containing an adhesive fluorine resin as the main component. The adhesive fluorine resin in the present invention means a fluorine resin of which melting point is 150° C.˜250° C. The adhesive fluorine resin in the invention also exhibits 4 N/cm or more of 180° angle peeling strength when 180° angle peeling strength is measured at peeling rate 5 mm/min and at the temperature of 23° C., by the method in accordance with JIS Z0237, with a sample obtained by pressing a kind of modified polyolefin resins “Rexparl RA3150” (manufactured by Japan Polyethylene Corporation) and the fluorine resin at a sample pressure of 4×10⁵˜5×10⁵ Pa at 240° C. for 10 minutes to make a laminate sheet; and then cutting into piece of 2.5 cm in width, 25 cm in length.

IR spectrum of the adhesive fluorine resin of the invention has absorption peaks between 1780 cm⁻¹˜1880 cm⁻¹. Preferably, IR spectrum of the adhesive fluorine resin has absorption peaks attributing to anhydrides such as maleic anhydride group between 1790 cm⁻¹˜1800 cm⁻¹ and 1845 cm⁻¹˜1855 cm⁻¹; or has absorption peaks attributing to terminal carbonate group between 1800 cm⁻¹˜1815 cm⁻¹; or has absorption peaks attributing to a mixture of anhydrides such as maleic anhydride group and terminal carbonate group between 1790 cm⁻¹˜1800 cm⁻¹, between 1845 cm⁻¹˜1855 cm⁻¹, and between 1800 cm⁻¹˜1815 cm⁻¹.

More preferably, IR spectrum of the adhesive fluorine resin has absorption peaks attributing to anhydrides such as maleic anhydride group between 1790 cm⁻¹˜1800 cm⁻¹ and between 1845 cm⁻¹˜1855 cm⁻¹; or has absorption peaks attributing to terminal carbonate group between 1800 cm⁻¹˜1815 cm⁻¹.

Further, ratio of the height of absorption peaks attributing to anhydrides such as maleic anhydride group between 1790 cm⁻¹˜1800 cm⁻¹ to the height of absorption peaks attributing to CH₂ group of the main chain around 2881 cm⁻¹ is 0.5˜1.5, preferably 0.7˜1.2, more preferably 0.8˜1.0.

The ratio of the height of absorption peaks attributing to terminal carbonate group between 1800 cm⁻¹˜1815 cm⁻¹ to the height of absorption peaks attributing to CH₂ group of the main chain around 2881 cm⁻¹ is 1.0˜2.0, preferably 1.2˜1.8, more preferably 1.5˜1.7.

As the fluorine resin having such adhesive strength, for example, there may be a homopolymer or a copolymer having tetrafluoroethylene units of which terminal or side chain has functional group such as carbonate group, carboxylic halide group, hydroxyl group, carboxyl group, and epoxy group. To realize the above melting point and adhesive strength, a plurality of resins may be mixed. Examples of commercially available fluorine resin which exhibits the above adhesive strength include “Neoflon EFEP” (manufactured by Daikin Industries, Ltd.) and “Fluon LM-ETFE AH2000” (manufactured by Asahi Glass Co., Ltd.).

(Layer 92 Consisting of the Modified Polyolefin Resin)

The layer 92 consisting of the modified polyolefin resin is a layer containing a modified polyolefin resin as the main component. The wording “modified polyolefin resin” of the invention means a resin obtained by graft reaction reacting the polyolefin resin as the base material with acids such as inorganic acid, unsaturated carboxylic acid, or derivatives thereof in any kind of methods. The polyolefin as the base material may be polyethylene, polypropylene, or the like. Examples of unsaturated carboxylic acids include boronic acid, acrylic acid, methacrylic acid, maliec acid, fumaric acid, itaconic acid, citraconic acid, or acid anhydrides thereof, ester thereof, amide thereof, imide thereof, metal salt thereof, and so on. As the modified polyolefin resin, copolymer of ethylene and glycidyl methacrylate is preferable. Examples of such copolymer of ethylene and glycidyl methacrylate may be “Rexparl RA3150” (manufactured by Japan Polyethylene Corporation) and “Bond first E” (manufactured by Sumitomo Chemical Co., Ltd.).

In the laminate film 100g for coating metal sheet of the sixth invention, total thickness of the layer 92 consisting of the modified polyolefin resin and the layer 25 consisting of the adhesive fluorine resin is preferably 10 μm or less, more preferably 5 μm or less. If the total thickness of the layer 92 consisting of the modified polyolefin resin and the layer 25 consisting of the adhesive fluorine resin is too thick, it becomes difficult to give emboss patterns. Thickness of the layer 92 consisting of the modified polyolefin resin and the layer 25 consisting of the adhesive fluorine resin is, in view of the strength thereof, it is preferably 1 μm or more, more preferably 3 μm or more.

<Laminate Film 100h for Coating Metal Sheet for Screen Board of the Seventh Invention>

FIG. 2(d) schematically shows a layer constitution of the laminate film 100h for coating metal sheet for screen board of the seventh invention. The laminate film 100h for coating metal sheet for screen board comprises: a base resin layer 30, an embossable layer 40, a layer 92 consisting of a modified polyolefin resin, a layer 94 consisting of an ethylene-vinylalcohol copolymer, and a layer 25 consisting of an adhesive fluorine resin; these layers are laminated in this order. The base resin layer 30 and the embossable layer 40 are the same as those of the fourth invention. Also, the layer 92 consisting of a modified polyolefin resin and the layer 25 consisting of an adhesive fluorine resin are the same as those of the sixth invention.

(Layer 94 consisting of an ethylene-vinylalcohol copolymer)

The layer 94 consisting of the ethylene-vinylalcohol copolymer is a layer containing the ethylene-vinylalcohol copolymer as the main component. About the ethylene-vinylalcohol copolymer to be used for the present invention, content ratio of ethylene is preferably 20˜65 mole %, more preferably 25˜60 moles. Saponified ratio of the vinylester component is preferably 90 mole % or more, more preferably 95 mole % or more.

The melt flow rate (MFR) of the ethylene-vinylalcohol copolymer measured in accordance with JIS K 7210 is preferably 8˜15, more preferably 10˜14.

In the seventh invention, total thickness of the layer 92 consisting of the modified polyolefin resin, the layer 94 consisting of the ethylene-vinylalcohol copolymer, and the layer 25 consisting of the adhesive fluorine resin is preferably 10 μm or less, more preferably 5 μm or less. If total thickness of the layer 92 consisting of the modified polyolefin resin, the layer 94 consisting of the ethylene-vinylalcohol copolymer, and the layer 25 consisting of the adhesive fluorine resin is too thick, it becomes difficult to give emboss patterns. The thickness of the layer 92 consisting of the modified polyolefin resin, the layer 94 consisting of the ethylene-vinylalcohol copolymer, and the layer 25 consisting of the adhesive fluorine resin is, in view of the strength, respectively, preferably 1 μm or more, more preferably 3 μm or more.

In the sixth and seventh inventions, on the layer 25 consisting of the adhesive fluorine resin, the layer 20 consisting of the fluorine resin can be further laminated. By having the layer 20 consisting of the fluorine resin in the surface, erasability of ink in the laminate film coated metal sheet 200b for screen board may be improved. The layer 20 consisting of the fluorine resin is the same as the examples described in the fourth invention. In the sixth invention, to an opposing surface of the layer 25 consisting of the adhesive fluorine resin to another surface thereof on which the layer 92 consisting of the modified polyolefin resin is laminated, the layer 20 consisting of the fluorine resin is laminated. In the seventh invention, an opposing surface of the layer 25 consisting of the adhesive fluorine resin to another surface thereof on which the layer 94 consisting of the ethylene-vinylalcohol copolymer is laminated, the layer 20 consisting of the fluorine resin is laminated.

Into the individual layers shown in the above fourth to seventh invention, in the range which does not undermine the nature thereof, various additives may be adequately added. Examples of the additives may be any kind of additives generally used for resin materials: such as various antioxidant like phosphorus series and phenol series antioxidants, heat stabilizer, ultraviolet absorber, light stabilizer, nucleating agent, metal deactivator, deactivator of residual polymerization catalyst, nucleation agent, antibacterial agent/fungicide, antistatic agent, lubricants, flame retardant, filler, and so on.

(Method for Manufacturing Laminate Films 100g, 100h for Coating Metal Sheet for Screen Board)

In the sixth invention, the laminate film 100g for coating metal sheet for screen board of the invention can be made by co-extruding the base resin layer 30, the embossable layer 40, the layer 92 consisting of the modified polyolefin resin, and the layer 25 consisting of the adhesive fluorine resin. In the co-extrusion forming, by using four extruding machines which are compatible with resin materials for forming the individual layers, these resin materials are fed into integrally coupled extrusion-dies and the fed resins are contacted at an inner part or opening of the dies so as to make the laminate film as a single extrusion product. Moreover, when the layer 20 consisting of the fluorine resin is to be laminated on the layer 25 consisting of the adhesive fluorine resin, five extrusion machines are used for co-extrusion forming in the same way as above.

In the seventh invention, the laminate film 100h for coating metal sheet for screen board of the invention can be made by co-extruding the base resin layer 30, the embossable layer 40, the layer 92 consisting of the modified polyolefin resin, the layer 94 consisting of the ethylene-vinylalcohol copolymer, and the layer 25 consisting of the adhesive fluorine resin. The co-extrusion is carried out with five extrusion machines in the same way as above. When the layer 20 consisting of the fluorine resin is laminated on the layer 25 consisting of the adhesive fluorine resin, six extrusion machines are used in the same way as above.

In the laminate films 100g, 100h of the sixth and seventh inventions, thickness of the layer 25 consisting of the adhesive fluorine resin can be thinner by the above co-extrusion forming. When the layer 20 consisting of the fluorine resin is laminated, thickness of the layer 20 consisting of the fluorine resin can be thinner. Accordingly, it is capable to reduce the usage of the expensive fluorine resin; therefore it is capable to manufacture the economically efficient laminate films 100g, 100h for coating metal sheet for screen board.

<Giving of Emboss Patterns>

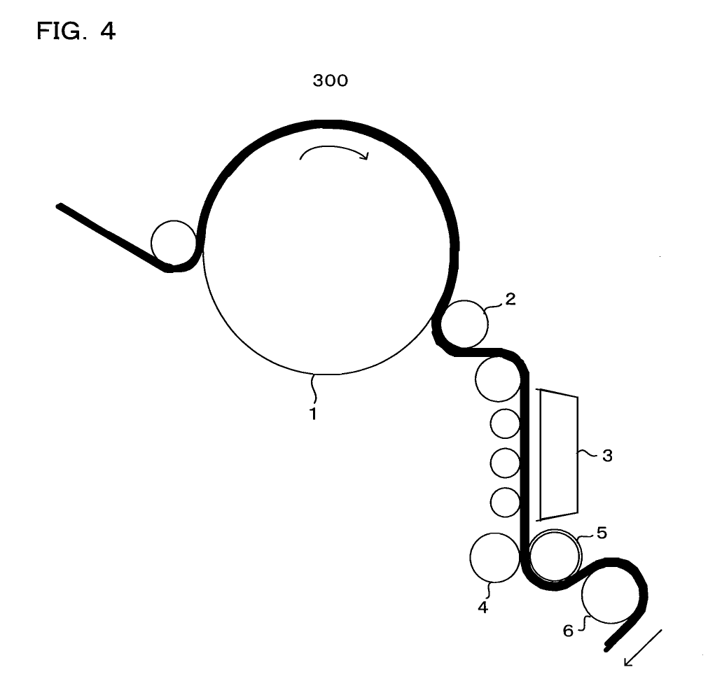

To the laminate films 100e˜100h for coating metal sheet for screen board described in the fourth to seventh inventions, emboss patterns are given. As the method to give the emboss patterns, for example, there may be a method by using the embossing machine 300 shown in FIG. 4. In the embossing machine 300, the laminate films 100e˜100h are fed into heating roll 1 and take-off roll 2 thereafter, and the films are treated by infrared heater 3, then, transferred to nip roll 4, emboss roll 5, and cooling roll 6 in this order such that the layer 20 consisting of the fluorine resin or the delaminatable resin layer 60 in the fourth and fifth inventions, and the layer 25 consisting of the adhesive fluorine resin or the layer 20 consisting of the fluorine resin in the sixth and seventh inventions contact with emboss roll 5.

Surface roughness of the laminate films 100e˜100h for coating metal sheet for screen board of which emboss patterns are given is defined as follows: Ra (center-line mean deviation of the profile) is preferably 0.7 μm or more and 5 μm or less; Ry (maximum height of the profile) is preferably 4 μm or more and 40 μm or less; Rz (ten-point height of irregularities) is preferably 3 μm or more and 30 μm or less; Rp (average depth profile) is preferably 1.5 μm or more and 20 μm or less; Pc (peak count) is preferably 7 or more and 50 or less, and gloss of the surface is preferably 50 or less.

<Laminate Film Coated Metal Sheet 200b for Screen Board>

FIG. 2(e) schematically shows the layer constitution of the laminate film coated metal sheet 200b for screen board of the invention. The laminate film coated metal sheet 200b for screen board of the invention can be made by adhering the base resin layer 30 side of the laminate films 100e˜100h for coating metal sheet for screen board to the metal sheet 10. As the method for adhering, for instance, there may be heat-sealing or dry-lamination. Adhesives used for dry-lamination may be the same as those of the above-described adhesives used for manufacturing the laminate films 100e, 100f. When dry-laminated, surface treatment or undercoating may be given on the surface to be dry-laminated.

While, if the emboss patterns are not given to the laminate films 100e˜100h as they are, the patterns may be given after the laminate film coated metal sheet 200b is ready.

<Laminate Film 100j for Coating Metal Sheet for Screen Board of the Ninth Invention>

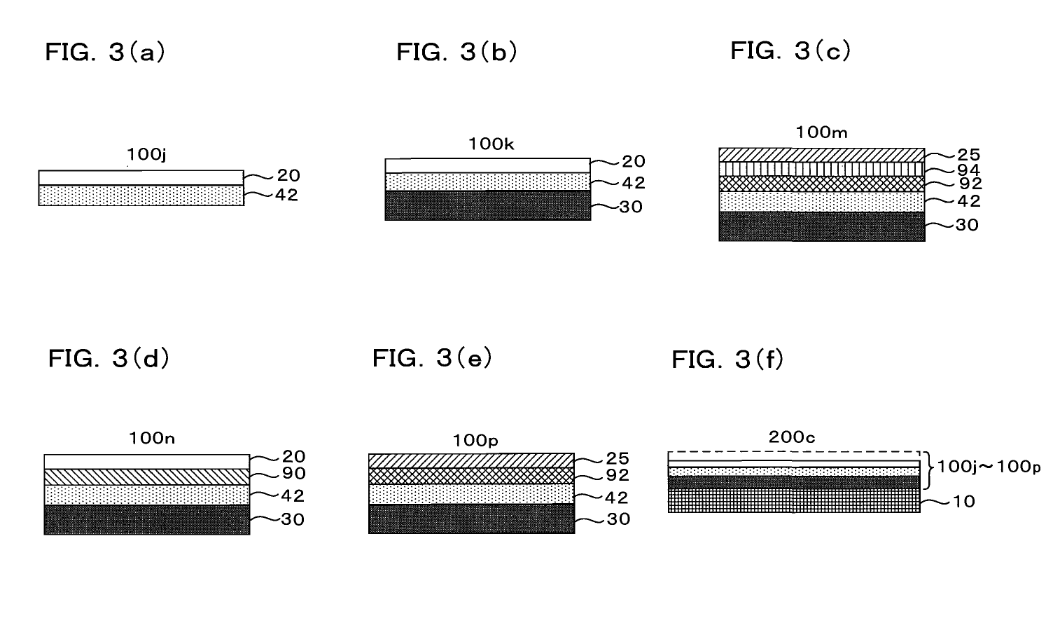

FIG. 3(a) schematically shows the layer constitution of the laminate film 100j for coating metal sheet for screen board of the ninth invention. The laminate film 100j for coating metal sheet for screen board has a constitution in which the layer 20 consisting of the fluorine resin is laminated on the layer 42 of which elastic modulus at 180° C.˜200° C. is 1.0×10⁷ Pa or less and elastic modulus at 120° C.˜160° C. is 1.0×10⁸ Pa or more. The layer 20 consisting of the fluorine resin is the same as the one described in the fourth invention.

(Layer 42 of which Elastic Modulus at 180° C.˜200° C. is 1.0×10⁷ Pa or Less and Elastic Modulus at 120° C.˜160° C. is 1.0×10⁸ Pa or More)

The layer 42 of which elastic modulus at 180° C.˜200° C. is 1.0×10⁷ Pa or less and elastic modulus at 120° C.˜160° C. is 1.0×10⁸ Pa or more (hereinafter, it may be omitted as “layer 42 having a predetermined elastic modulus”.) is a layer giving emboss patterns to the laminate film for coating metal sheet for screen board of the invention. The embossable layer needs to lower the elastic modulus thereof at an embossable temperature. However, it is not sufficient; in a circumstance where the laminate film for coating metal sheet for screen board is bonded by thermo-compression to the metal sheet 10 after giving emboss patterns, when the laminate film is heated, predetermined elastic modulus is necessary secured and emboss reversion has to be inhibited. From this point of view, the inventors of the invention successfully made the laminate film 100j for coating metal sheet for screen board by placing the layer 42 of which elastic modulus at 180° C.˜200° C. as the embossable temperature is 1.0×10⁷ Pa or less, and elastic modulus at 120° C.˜160° C. as the thermo-compression to the metal sheet 10 is 1.0×10⁸ Pa or more in the laminate film. The laminate film 100j for coating metal sheet for screen board exhibits excellent embossability and capable to inhibit emboss reversion.

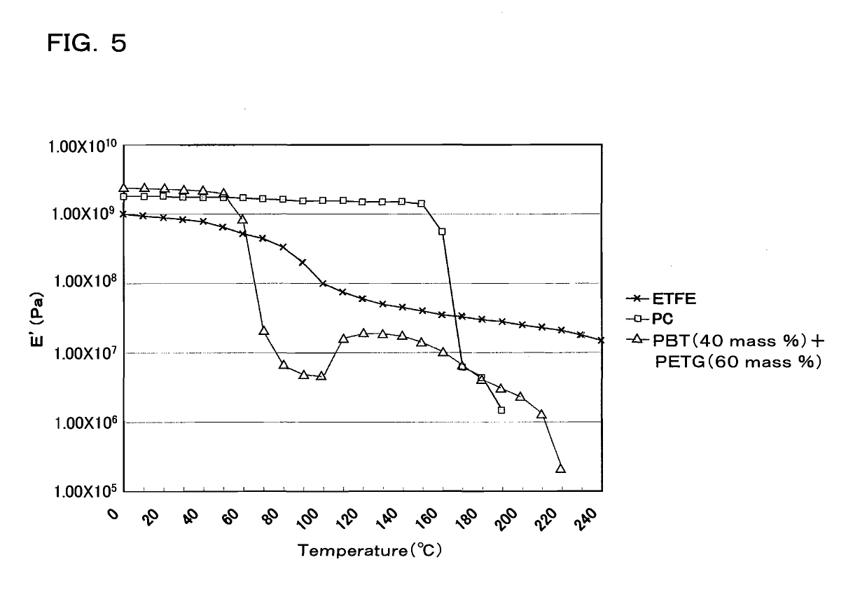

An example of the layer 42 having a predetermined elastic modulus is a layer containing the polycarbonate resin as the main component. FIG. 5 shows a graph indicating the varying elastic moduli by temperature of the polycarbonate resin, the fluorine resin, and the polyester resin. At 180° C.˜200° C. as the embossable temperature, the polycarbonate resin and the polyester resin exhibit excellent embossability, since the elastic modulus thereof is 1.0×10⁷ Pa or less. While, the fluorine resin exhibits high elastic modulus at the embossable temperature, thereby emboss workability is bad. However, as thickness of the layer 20 consisting of the fluorine resin is thin in the laminate film for coating metal sheet for screen board of the invention, embossing the layer underneath the fluorine resin can be carried out so as to form a shape along the embossing of the layer 20 consisting of the fluorine resin.

As described above, embossability of both the polycarbonate resin and the polyester resin is favorable. Nevertheless, at the laminating temperature to the metal sheet 10, there is a gap of elastic modulus between these two resins. In FIG. 5, as seen from the temperature range of 120° C.˜160° C. as the laminating temperature to the metal sheet 10, the polycarbonate series resin indicates the elastic modulus thereof at 1.0×10⁸ Pa or more, i.e. the polycarbonate series resin maintains high elastic modulus. On the other hand, the polyester resin indicates the elastic modulus at 1.0×10⁸ Pa or less. If the polyester series resin is used as an embossable layer, emboss reversion occurs during the lamination of the embossed layer to the metal sheet. The film of the present invention is a superior laminate film 100j for coating metal sheet for screen board which solves this problem.

The layer 42 having a predetermined elastic modulus may contain the above described additives in the range which does not undermine the nature thereof of the invention. In addition, thickness of the layer 42 having a predetermined elastic modulus is preferably 10˜100 μm, more preferably 30˜50 μm.

<Laminate Film 100k for Coating Metal Sheet for Screen Board of the Tenth Invention>

FIG. 3(b) schematically shows a layer constitution of the laminate film 100k for coating metal sheet for screen board of the tenth invention. The laminate film 100k for coating metal sheet for screen board comprises a base resin layer 30, a layer 42 having predetermined elastic modulus thereon, and a layer 20 consisting of the fluorine resin placed on top thereof. The base resin layer 30 is the same as the one described in the fourth invention. Moreover, the layer 42 having a predetermined elastic modulus is same as the one described in the ninth invention. Further, the layer 20 consisting of the fluorine resin is same as the one described in the fourth invention.

<Laminate Film 100m for Coating Metal Sheet for Screen Board of the Eleventh Invention>

FIG. 3(c) schematically shows the layer constitution of the laminate film 100m for coating metal sheet for screen board of the eleventh invention. The laminate film 100m for coating metal sheet for screen board comprises a base resin layer 30, a layer 42 having a predetermined elastic modulus thereon, a layer 92 consisting of a modified polyolefin resin thereon, further, a layer 94 consisting of a ethylene-vinylalcohol copolymer, and the layer 25 consisting of an adhesive fluorine resin on top thereof.

The base resin layer 30 is the same as the one described in the fourth invention. Also, the layer 42 having the predetermined elastic modulus is the same as the one described in the ninth invention. Further, the layer 92 consisting of the modified polyolefin resin, and the layer 94 consisting of the ethylene-vinylalcohol copolymer are the same as those of the seventh invention.

<Laminate Film 100n for Coating Metal Sheet for Screen Board of the Twelfth Invention>

FIG. 3(d) schematically shows the layer constitution of the laminate film 100n for coating metal sheet for screen board of the twelfth invention. The laminate film 100n for coating metal sheet for screen board comprises a base resin layer 30, a layer 42 having a predetermined elastic modulus thereon, a layer 90 consisting of tetrafluoroethylene-hexafluoropropylene-vinylidene fluoride copolymer thereon, and a layer 20 consisting of a fluorine resin on top thereof.

The base resin layer 30 is the same as the one described in the fourth invention. Moreover, the layer 42 having the predetermined elastic modulus is the same one described in the ninth invention. Further, the layer 90 consisting of tetrafluoroethylene-hexafluoropropylene-vinylidene fluoride copolymer, and the layer 20 consisting of fluorine resin are same as those in the fifth invention.

<Laminate Film 100p for Coating Metal Sheet for Screen Board of the Thirteenth Invention>

FIG. 3(e) schematically shows a layer constitution of the laminate film 100p for coating metal sheet for screen board of the thirteenth invention. The laminate film 100p for coating metal sheet for screen board comprises a base resin layer 30, a layer 42 having a predetermined elastic modulus thereon, further, a layer 92 consisting of a modified polyolefin resin, and a layer 25 consisting of an adhesive fluorine resin on top thereof.

The base resin layer 30 is the same as the one described in the fourth invention. The layer 42 having the predetermined elastic modulus is the same as the one described in the ninth invention. Further, the layer 92 consisting of the modified polyolefin resin and the layer 25 consisting of the adhesive fluorine resin are the same as those of the eleventh invention.

On the individual surfaces of the laminate film 100j of the ninth invention to the laminate film 100p of the thirteenth invention, a delaminatable resin layer 60 may further be formed. The delaminatable resin layer 60 is the same as the one described in the fourth invention. Further, on the layer 25 consisting of the adhesive fluorine resin of the individual laminate film 100m of the eleventh invention and the laminate film 100p of the thirteenth invention, the layer 20 consisting of fluorine resin may be formed.

The laminate film 100j of the ninth invention can be obtained by dry-laminating the layer 20 consisting of fluorine resin side of the laminate film formed by co-extruding the delaminatable resin layer 60 and the layer 20 consisting of the fluorine resin, on the layer 42 having the predetermined elastic modulus.

The laminate film 100k of the tenth invention can be obtained, by dry-laminating the layer 20 consisting of fluorine resin side of the laminate film formed by co-extruding the delaminatable resin layer 60 and the layer 20 consisting of the fluorine resin, on the layer 42 having the predetermined elastic modulus, and further dry-laminating the layer 42 having the predetermined elastic modulus on the base resin layer 30.

The laminate film 100m of the eleventh invention can be obtained by dry-laminating the layer 92 consisting of the modified polyolefin resin side of the laminate film formed by co-extrusion of the delaminatable resin layer 60, the layer 25 consisting of the adhesive fluorine resin, the layer 94 consisting of the ethylene-vinylalcohol copolymer, and the layer 92 consisting of the modified polyolefin resin, on the layer 42 having the predetermined elastic modulus, and further dry-laminating the layer 42 having the predetermined elastic modulus on the base resin layer 30.

The laminate film 100n of the twelfth invention can be made by dry-laminating the layer 90 consisting of tetrafluoroethylene-hexafluoropropylene-vinylidene fluoride copolymer side of the laminate film formed by co-extrusion of the delaminatable resin layer 60, the layer 20 consisting of the fluorine resin, and the layer 90 consisting of tetrafluoroethylene-hexafluoropropylene-vinylidene fluoride copolymer, on the layer 42 having the predetermined elastic modulus, and further dry-laminating the layer 42 having the predetermined elastic modulus on the base resin layer 30.

The laminate film 100p of the thirteenth invention can be obtained by dry-laminating the layer 92 consisting of the modified polyolefin resin side of the laminate film formed by co-extrusion of the delaminatable resin layer 60, the layer 25 consisting of the adhesive fluorine resin, and the layer 92 consisting of the modified polyolefin resin, on the layer 42 having the predetermined elastic modulus, and further dry-laminating the layer 42 having the predetermined elastic modulus on the base resin layer 30.

In the individual surface of the laminate films 100j˜100p of the ninth to thirteenth inventions, emboss is given. The method for embossing and the shape-and-patterns of the emboss are the same as previously described in the laminate film 100e of the fourth invention.

<Laminate Film Coated Metal Sheet for Screen Board 200c>

In the laminate film 100j of the ninth invention, the laminate film coated metal sheet for screen board 200c can be made by adhering the layer 42 having the predetermined elastic modulus side thereof to the metal sheet 10. While, in the laminate films 100k, 100m, 100n, and 100p of the tenth to thirteenth inventions, the laminate film coated metal sheet for screen board 200c can be made by adhering the base resin layer 30 side thereof to the metal sheet 10. Method for adhering these are the same as the way previously described in the laminate film coated metal sheet for screen board 200b.

### EXAMPLES

### Laminate Film for Coating Metal Sheet

### <1> Preparation of Test Pieces for Evaluation

In the Examples 1˜2 and Comparative examples 1˜3 below, the objective laminate films for coating metal sheet (one of them is a monolayer film) each having the layer constitution under the particular lamination conditions were obtained.

### Example 1

By use of the following resins, co-extruding forming with two-layer multi-manifold dies at the extruding-gate temperature 315° C. was carried out. Thickness of each layer of the obtained laminate film is specified below:

The first layer: polyethylene resin, “Novatec HD HY540” (manufactured by Japan Polyethylene Corporation): 15 μm; and
The second layer: ethylene-tetrafluoroethylene copolymer, “Fluon ETFE C-88AXP” (manufactured by Asahi Glass Co., Ltd.): 5 μm.

Moreover, the laminate films obtained by the above co-extrusion were dry-laminated on the transparent resin layer consisting of the polyester series resin described below by use of adhesives, specifically the polyester series adhesive (blended resin having 5 parts by mass of “Takenate A3” and 100 parts by mass of “Takerack A310” (both manufactured by Mitsui Takeda Chemicals, Inc.)) (3 g/m²), and further dry-laminating the above laminate film onto the non-elongated layer consisting of the following polyester series resin. Thickness of the individual layers of the obtained laminate film is specified below:

The third layer: transparent resin layer consisting of the polyester series resin, “T 100-50” (manufactured by Mitsubishi Polyester Film Corporation): 50 μm; and
The fourth layer: non-elongated layer consisting of the polyester series resin, a mixed resin having 40 mass % of PBT (“Novaduran 5020S” (manufactured by Mitsubish Engineering-Plastics Corporation)) and 60 mass % of PETG (“Easter PETG 6763” (manufactured by Eastman Chemical Company)) (to total mass of the mixed resin as 100 parts by mass, 20 parts by mass of oxide titanium series white pigment is added.): 50 μm.

### Example 2

By use of the following resins, co-extruding forming with two-layer multi-manifold dies at the extruding-gate temperature 315° C. was carried out. Thickness of each layer of the obtained laminate film is specified below:

The first layer: polyethylene resin, “Novatec HD HY540” (manufactured by Japan Polyethylene Corporation): 15 μm; and
The second layer: ethylene-tetrafluoroethylene copolymer, “Fluon ETFE C-88AXP” (manufactured by Asahi Glass Co., Ltd.): 5 μm.

Moreover, the laminate film obtained by the above co-extrusion was dry-laminated on the non-elongated layer consisting of the polyester series resin described below by use of adhesives, specifically the polyester series adhesive (blended resin having 5 parts by mass of “Takenate A3” and 100 parts by mass of “Takerack A310” (both manufactured by Mitsui Takeda Chemicals, Inc.)) (3 g/m²). The obtained laminate film has layers of which thickness is specified below:

The third layer: non-elongated layer consisting of the polyester series resin, a mixed resin having 40 mass % of PBT (“Novaduran 5020S” (manufactured by Mitsubish Engineering-Plastics Corporation)) and 60 mass % of PETG (“Easter PETG 6763” (manufactured by Eastman Chemical Company)) (to total mass of the mixed resin as 100 parts by mass, 20 parts by mass of oxide titanium series white pigment is added.): 100 μm.

### Comparative Example 1

By dry-laminating the following resins with the polyester series adhesive (blended resin having 5 parts by mass of “Takenate A3” and 100 parts by mass of “Takerack A310” (both manufactured by Mitsui Takeda Chemicals, Inc.)), the laminate film of which individual layers have the thickness specified as follows was obtained:

The first layer: ethylene-tetrafluoroethylene copolymer, “Fluon ETFE C-88AXP” (manufactured by Asahi Glass Co., Ltd.): 25 μm;
The second layer: transparent resin layer consisting of the polyester series resin, “T100-50” (manufactured by Mitsubishi Polyester Film Corporation): 50 μm; and
The third layer: non-elongated layer consisting of polyester series resin, a mixed resin having 40 mass % of PBT (“Novaduran 5020S” (manufactured by Mitsubish Engineering-Plastics Corporation)) and 60 mass % of PETG (“Easter PETG 6763” (manufactured by Eastman Chemical Company)) (to total mass of the mixed resin as 100 parts by mass, 20 parts by mass of oxide titanium series white pigment was added.): 50 μm.

### Comparative Example 2

By dry-laminating the following resins with the polyester series adhesive (blended resin having 5 parts by mass of “Takenate A3” and 100 parts by mass of “Takerack A310” (both manufactured by Mitsui Takeda Chemicals, Inc.)), the laminate film of which each layer has the thickness specified as follows was obtained:

The first layer: ethylene-tetrafluoroethylene copolymer, “Fluon ETFE C-88AXP” (manufactured by Asahi Glass Co., Ltd.): 50 μm; and
The second layer: non-elongated layer consisting of the polyester series resin, a mixed resin having 40 mass % of PBT (“Novaduran 5020S” (manufactured by Mitsubish Engineering-Plastics Corporation)) and 60 mass % of PETG (“Easter PETG 6763” (manufactured by Eastman Chemical Company)) (to total mass of the mixed resin as 100 parts by mass, 20 parts by mass of oxide titanium series white pigment was added.): 100 μm.

### Comparative Example 3

A monolayer film of which thickness was 100 μm consisting of the non-elongated layer consisting of the polyester series resin (a mixed resin having 40 mass % of PBT (“Novaduran 5020S” (manufactured by Mitsubish Engineering-Plastics Corporation)) and 60 mass % of PETG (“Easter PETG 6763” (manufactured by Eastman Chemical Company)) (to total mass of the mixed resin as 100 parts by mass, 20 parts by mass of oxide titanium series white pigment was added.) was made.

### <2> Evaluation Items of the Laminate Film for Coating Metal Sheet

The laminate films for coating metal sheet previously made were evaluated in accordance with the following evaluation items. The results are shown in Table 1.

(1) Co-Extrusion Workability

◯ (good): a film can be stably obtained by co-extrusion;

X (bad): a film cannot be stably wound due to the inter-layer peeling during the co-extrusion.

(2) Dry-Lamination Workability

◯ (good): it is capable to adhere the each layer without making any wrinkles;

X (bad): wrinkles are made when adhering each layer.

(3) Inter-Layer Adhesiveness

◯ (good): no inter-layer peeling is caused;

X (bad): inter-layer peeling is caused when the film is wound.

(4) Adhesiveness to the Metal Sheet

To a galvanized steel sheet (thickness: 0.45 mm), a polyester series adhesive (“SC611” (manufactured by Sony Chemicals Corporation)) is applied so as the dried adhesive thickness to be about 2˜4 μm; and so as the adhesive-applied surface of the steel sheet to be at the temperature of 235° C., the surface was dried and heated by a hot-air oven and an infrared heater. Later, by use of a roll-laminator, the adhesive-applied surface of the steel sheet is coated with the laminate film of the present invention and is naturally cooled at room temperature to make a resin-coated steel sheet coated by the laminate film of the invention.

The adhesion of the above resin-coated steel sheets was evaluated in accordance with the following criteria.

⊚ (very good): adhesion is carried out without making wrinkles, and adhesiveness to the metal sheet is excellent;

◯ (good): adhesion is carried out without making wrinkles, and adhesiveness to the metal sheet is good; and

X (bad): wrinkles are made. Or, adhesiveness to the steel sheet is bad.

(5) Surface Antifouling Property

Letters were written on the surface of the laminate film for coating metal sheet by oil-based fiber-tip marker, and 60 seconds later, the letters were wiped out by water. The surface antifouling property was evaluated from the remained ink in accordance with the following criteria.

◯ (good): the ink can be completely wiped out; and

X (bad): the ink is hardly wiped out, the ink remains on the film.

(6) Economic Efficiency

Cost for manufacturing the laminate film for coating metal sheet was evaluated as follows.

⊚ (very good): it costs little;

◯ (good): it does not cost a lot; and

X (bad): it costs a lot.

TABLE 1

| | | | Compar- | Compar- | Compar- |
|---|---|---|---|---|---|
| | Exam- | Exam- | ative | ative | ative |
| | ple 1 | ple 2 | example 1 | example 2 | example 3 |
| Co-extrusion | ◯ | ◯ | — | — | — |
| workability | | | | | |
| Dry-lamination | ◯ | ◯ | ◯ | X | — |
| workability | | | | | |
| Inter-layer | ◯ | ◯ | ◯ | X | — |
| adhesiveness | | | | | |
| Adhesiveness | ◯ | ◯ | ◯ | X | ⊚ |
| to the metal | | | | | |
| sheet | | | | | |
| Surface | ◯ | ◯ | ◯ | ◯ | X |
| antifouling | | | | | |
| property | | | | | |
| Economic | ◯ | ⊚ | X | X | ⊚ |
| efficiency | | | | | |

As seen from Table 1, the laminate film for coating metal sheets of the present invention (Examples 1˜2) exhibited excellent results in any evaluation items. On the other hand, if thickness of the layer consisting of the fluorine resin was thick (Comparative example 1), as it requires large quantity of the expensive fluorine series resin, its economic efficiency was inferior. When the monolayer consisting of thin-layer fluorine resin was used (Comparative example 2), at a phase of adhering it to the non-elongated layer consisting of the polyester series resin, wrinkles were made in the fluorine resin, thereby adhesion workability was inferior. Therefore, the dry-lamination workability was inferior. Further, when the monolayer film of non-elongated layer consisting of the polyester series resin (Comparative example 3) was used, surface antifouling property was inferior.

<Laminate Film for Coating Metal Sheet for Screen Board>

### Example 3

By use of the following resins, co-extruding forming with two-layer multi-manifold dies at the extruding-gate temperature 315° C. was carried out. Thickness of each layer of the obtained laminate film is specified below:

The first layer: polyethylene resin, “Novatec HD HY540” (manufactured by Japan Polyethylene Corporation): 15 μm; and
The second layer: ethylene-tetrafluoroethylene copolymer, “Fluon ETFE C-88AXP” (manufactured by Asahi Glass Co., Ltd.): 5 μm.

Moreover, the laminate film obtained by the above co-extrusion was dry-laminated on the embossable layer side of the co-extruded film (co-extruded with two-layer multi-manifold dies at the extruding-gate temperature 280° C.) having the layer constitution described below by use of adhesives, specifically the polyester series adhesive (blended resin having 5 parts by mass of “Takenate A3” and 100 parts by mass of “Takerack A310” (both manufactured by Mitsui Takeda Chemicals, Inc.)) (3 g/m²).

The third layer: embossable layer consisting of the polyester series resin, a mixed resin having 40 mass % of PBT (“Novaduran 5020S” (manufactured by Mitsubish Engineering-Plastics Corporation)) and 60 mass % of PETG (“Easter PETG 6763” (manufactured by Eastman Chemical Company)) (to total mass of the mixed resin as 100 parts by mass, 20 parts by mass of oxide titanium series white pigment was added.): 70 μm; and
The fourth layer: base resin layer, PBT (“Novaduran 5008” (manufactured by Mitsubish Engineering-Plastics Corporation), glass transition point: 46° C., temperature of crystal melting peak: 221° C.): 100 μm.

Then, by use of the embossing machine shown in FIG. 4, embossing A was carried out to the laminate film manufactured at the film heating-up temperature of 180° C., and at the rate of 10 m/min between a pair of rolls having the roll surface pressure of 2 MPa. The wording “embossing A” means embossing of which Ra is 2 μm, Ry is 11 μm, Rz is 9.9 μm, Rp is 5.5 μm, Pc is 11, and gloss (60° C., specular gloss) is 40 or less.

Next, the acrylic series thermoset adhesive (manufactured by Mitsubishi Rayon Co., Ltd.) generally used for the polyvinyl-chloride coated metal sheet is applied on the surface of the 1.6 mm thick galvanized steel sheet so as the thickness of the adhesive to become around 2˜4 μm after drying. The surface where the adhesive was applied was dried and heated by a hot-air oven and an infrared heater, the surface temperature of the galvanized steel sheet was set to 225° C. Immediately after that, by use of a roll-laminator, the base resin layer side of the above laminate film was adhered to the surface of the steel sheet where the adhesive had been applied, and cooled with water to obtain a laminate film coated metal sheet for screen board.

### Example 4

In Example 3, except for changing the layer thickness of the layer consisting of the fluorine resin to 8 μm, Example 4 was carried out in the same way as Example 3 to obtain a laminate film and a laminate film coated metal sheet for screen board.

### Reference Example 1

In Example 3, except for changing the layer thickness of the layer consisting of the fluorine resin to 20 μm, and giving embossing B to the layer, Reference example 1 was carried out in the same way as Example 3 to obtain a laminate film and a laminate film coated metal sheet for screen board. The wording “embossing B” means embossing of which Ra is 0.5 μm, Ry is 2 μm, Rz is 2 μm, Rp is fpm, Pc is 6, and gloss (60° C., specular gloss) is 70.

### Reference Example 2

In Example 3, except for giving embossing B, Reference example 2 was carried out in the same way as Example 3 to obtain a laminate film and a laminate film coated metal sheet for screen board.

### Comparative Example 4

The mat-processed film consisting of ethylene-tetrafluoroethylene (Aflex 21GNS, 21 μm (manufactured by Asahi Glass Co., Ltd.)) was dry-laminated to the white film consisting of the polyethylene terephthalate (50 μm of “Crisper”, manufactured by Toyobo Co., Ltd.), to obtain the laminate film. And, the laminate film coated metal sheet for screen board was obtained in the same way as Example 3.

(Evaluation Method)

(Embossability)

The embossed sheet was visually observed. The sheet in which emboss patterns were beautifully given was evaluated as good (◯); whereas, transcription of the emboss patterns was slightly light was evaluated as not bad (Δ); transcription of the same was bad and emboss patterns were light, or the surface was simply rough irrelevant to the emboss patterns was evaluated as bad (X).

(Erasability)

Letters were written on the surface of the laminate film for coating metal sheet by oil-based fiber-tip marker, and 60 seconds later, the letters were wiped out by towel. The surface antifouling property was evaluated from the remained ink in accordance with the following criteria.

◯ (good): the ink can be completely wiped out; and

X (bad): the ink is partly remained on the film.

(Anti-Glare Property)

Under a circumstance where beams of 40 W halogen lump is incidented into the surface at 45° angle from 30 cm distance, the surface of laminate film coated metal sheet was visually observed in accordance with the following criteria.

◯ (good): there is no reflection of light, therefore surface of the film can be observed; and

X (bad): light is reflected, therefore surface of the same cannot be observed.

(Economic Efficiency)

Costs for manufacturing the laminate film and the laminate film coated metal sheet were evaluated as follows.

◯ (good): the cost is low;

X (bad): the cost is high.

(Evaluation Results)

TABLE 2

| | Exam- | Exam- | Reference | Reference | Comparative |
|---|---|---|---|---|---|
| | ple 3 | ple 4 | example 1 | example 2 | example 4 |
| Embossability | ◯ | ◯ | X | ◯ | — |
| Embossing | A | A | B | B | B |
| Erasability | ◯ | ◯ | ◯ | ◯ | X |
| Anti-glare | ◯ | ◯ | X | X | ◯ |
| property | | | | | |
| Economic | ◯ | ◯ | X | ◯ | X |
| efficiency | | | | | |

The laminate film and the laminate film coated metal sheet of the invention (Examples 3 and 4) both exhibited excellent results in all the evaluation items. On the other hand, in Reference example 1, the layer consisting of the fluorine resin was too thick, embossability and economic efficiency was inferior to examples 3 and 4. Moreover, Reference examples 1 and 2 were the one of which embossing was out of the preferable range of the present invention, thus the anti-glair property was inferior. Further, in Comparative example 4, as it used the mat-processed fluorine resin layer, it lacked erasability and lacked the economic efficiency because the layer thickness of the fluorine resin was thick.

<Laminate Film for Coating Metal Sheet for Screen Board>

### Example 5

By use of the following resins, co-extruding forming with two-layer multi-manifold dies at the extruding-gate temperature 315° C. was carried out. Thickness of each layer of the obtained laminate film is specified below:

The first layer: polyethylene resin, “Novatec HD HY540” (manufactured by Japan Polyethylene Corporation): 15 μm; and
The second layer: ethylene-tetrafluoroethylene copolymer, “Fluon ETFE C-88AXP” (manufactured by Asahi Glass Co., Ltd.): 5 μm.

Moreover, the laminate film obtained by the above co-extrusion was dry-laminated to the following polycarbonate resin sheet as the third layer by use of adhesives, specifically the polyester series adhesive (blended resin having 5 parts by mass of “Takenate A3” and 100 parts by mass of “Takerack A310” (both manufactured by Mitsui Takeda Chemicals, Inc.)) (3 g/m²).

The third layer: polycarbonate resin, “Novalex 7027R” (manufactured by Mitsubish Engineering-Plastics Corporation): 38 μm.

The polycarbonate resin sheet of the third layer was made by co-extrusion forming with T-dies of which extruding-gate has 1200 mm in width and was heated at the temperature of 300° C.

Separated from the laminate film having the above first to third layers, a sheet to be the following fourth layer was made by extrusion-forming with T-dies of which extruding-gate was 1200 mm in width and was heated at the temperature of 280° C.

The fourth layer: polyester series resin, a mixed resin having 40 mass % of PBT (“Novaduran 5020S” (manufactured by Mitsubish Engineering-Plastics Corporation)) and 60 mass % of PETG (“Easter PETG 6763” (manufactured by Eastman Chemical Company)) (to total mass of the mixed resin as 100 parts by mass, 20 parts by mass of oxide titanium series white pigment is added.): 150 μm.

Then, the first layer in the laminate film having the above first to the third layers was peeled; the remained laminate film having the second layer and the third layer was fed into the embossing machine shown in FIG. 4 such that the above-described the fourth layer sheet is superposed onto the third layer side of the remained laminate film; these three layers were thermally compressed at the film heating-up temperature of 180° C., and at the rate of 10 m/min between a pair of rolls having the roll surface pressure of 2 MPa to make a laminate film having the second to the fourth layers; and embossing A was given to the obtained laminate film.

Thereafter, the acrylic series thermoset adhesive (manufactured by Mitsubishi Rayon Co., Ltd.) generally used for polyvinyl chloride coated metal sheet was applied to the surface of the 1.6 mm thick galvanized steel sheet so as the thickness of the adhesive to become around 2˜4 μm after drying. The surface where the adhesive was applied was dried and heated by a hot-air oven and an infrared heater, the surface temperature of the galvanized steel sheet was set to 225° C. Immediately after that, by use of a roll-laminator, the polyester series resin layer side of the above laminate film is adhered to the surface of the steel sheet where the adhesive is applied, and cooled with water to obtain a laminate film coated metal sheet for screen board.

### Example 6

Except for changing thickness of the layer consisting of ethylene-tetrafluoroethylene of the first layer to 8 μm, Example 6 was carried out in the same way as Example 5 to obtain the laminate film and the laminate film coated metal sheet.

### Reference Example 3

By dry-laminating the following resins through the adhesive (blended resin having 5 parts by mass of “Takenate A3” and 100 parts by mass of “Takerack A310” (both manufactured by Mitsui Takeda Chemicals, Inc.)), the laminate film of which each layer has the thickness specified as follows is obtained:

The first layer: ethylene-tetrafluoroethylene copolymer, “Fluon ETFE C-88AXP” (manufactured by Asahi Glass Co., Ltd.): 12 μm; and
The second layer: polyester series resin, a mixed resin having 40 mass % of PBT (“Novaduran 5020S” (manufactured by Mitsubish Engineering-Plastics Corporation)) and 60 mass % of PETG (“Easter PETG 6763” (manufactured by Eastman Chemical Company)) (to total mass of the mixed resin as 100 parts by mass, 20 parts by mass of oxide titanium series white pigment was added.): 50 μm.

Then, by using the embossing machine shown in FIG. 4, embossing B was given to the obtained laminate film at the film heating-up temperature of 180° C., and at the rate of 10 m/min between the pair of rolls having the roll surface pressure of 2 MPa.

### Reference Example 4

Except for changing thickness of the layer consisting of the ethylene-tetrafluoroethylene of the first layer to 5 μm, Reference example 4 was carried out in the same way as Reference example 3 to obtain the laminate film and the laminate film coated metal sheet.

### Reference Example 5

The mat-processed film consisting of the ethylene-tetrafluoroethylene copolymer “Aflex 21GNS” (manufactured by Asahi Glass Co., Ltd., 21 μm) was dry-laminated to the polyester film of the second layer of Reference example 3 to obtain the laminate film. As the adhesive for dry-lamination, the same one used in Reference example 3 was used. And, Reference example 5 was carried out in the same way as Reference example 3 to make the laminate film coated metal sheet.

### Comparative Example 5

To the monolayer film consisting of the polyester film of the second layer of Reference example 3, embossing A was given under the same condition as that of Example 5. Comparative example 5 was carried out in the same way as Reference example 3 to obtain the laminate film coated metal sheet.

(Evaluation Method)

These films made as above were evaluated in accordance with the following criteria.

(Embossability)

The embossed sheets were visually observed. The sheet in which emboss patterns were beautifully given was evaluated as good (◯); whereas, transcription of the emboss patterns was slightly light was evaluated as not bad (Δ); transcription of the same was bad and emboss patterns were light, or the surface was simply rough irrelevant to the emboss patterns was evaluated as bad (X).

(Existence of Emboss Reversion)

Existence of emboss reversion at a phase of heat-lamination to the steel sheet was visually observed. If emboss reversion is not occurred, it is evaluated as good (◯); while, if emboss reversion is occurred, it is evaluated as bad (X).

(Erasability)

Letters were written on the surface of the laminate film for coating metal sheet by oil-based fiber-tip marker, and 60 seconds later, the letters were wiped out by towel. The surface antifouling property was evaluated from the remained ink in accordance with the following criteria.

◯ (good): the ink can be completely wiped out; and

X (bad): the ink is partly remained on the film.

(Anti-Glare Property)

Under a circumstance where beams of 40 W halogen lump was incidented into the surface at 45° angle from 30 cm distance, the surface of laminate film coated metal sheet was visually observed in accordance with the following criteria.

◯ (good: there is no reflection of light, therefore surface of the film can be observed; and

X (bad): light is reflected, therefore surface of the same cannot be observed.

(Evaluation Results)

TABLE 3

| | | | Reference | Reference | Reference | Comparative |
|---|---|---|---|---|---|---|
| | Example 5 | Example 6 | example 3 | example 4 | example 5 | example 5 |
| Embossability | ◯ | ◯ | X | ◯ | — | ◯ |
| Existence of | ◯ | ◯ | X | X | — | X |
| Emboss reversion | | | | | | |
| Embossing | A | A | B | B | B | A |
| Erasability | ◯ | ◯ | ◯ | ◯ | X | X |
| Anti-glare property | ◯ | ◯ | X | X | ◯ | X |

In Reference example 3, since thickness of the fluorine resin layer was thick, it lacked embossability. In Reference examples 3 and 4, and Comparative example 5, as there was no polycarbonate layer existed, emboss reversion was occurred. In addition, in Reference examples 3 and 4, as embossing was out of the preferable range of the present invention, it lacked the anti-glare property. Further, since Reference example 5 did not have surface emboss but just mat-processed, in the same way, Comparative example 5 did not have the fluorine resin layer on the surface, the laminate film of both examples lacked the anti-glare property.

The above has described the present invention associated with the most practical and preferred embodiments thereof. However, the invention is not limited to the embodiments disclosed in the specification. Thus, the invention can be appropriately varied as long as the variation is not contrary to the subject substance and conception of the invention which can be read out from the claims and the whole contents of the specification. It should be understood that laminate film for coating metal sheet and the laminate film for coating metal sheet for screen board with such an alternation are included in the technical scope of the invention.

1. A method for producing a laminate film for coating a metal sheet for a screen board for laminating on a metal surface, wherein the laminate film comprises:
(i) a layer having elastic modulus at a temperature from 180° C. to 200° C. of 1.0×10⁷ Pa or less and elastic modulus at a temperature from 120° C. to 160° C. of 1.0×10⁸ Pa or more, and
(ii) a layer comprising a fluorine resin, as the main component, on the top of the layer (i),
the method comprising:
laminating the layer (ii) and a delaminatable resin layer by co-extrusion; and
laminating the layer (i) on the layer (ii) opposite to the delaminatable resin layer.

2. A method for producing a laminate film for coating a metal sheet for a screen board for laminating on a metal surface, wherein the laminate film comprises:
a base resin layer;
(i) a layer having elastic modulus at a temperature from 180° C. to 200° C. of 1.0×10⁷ Pa or less and elastic modulus at a temperature from 120° C. to 160° C. of 1.0×10⁸ Pa or more; and
(ii) a layer comprising a fluorine resin, as the main component, on the top of the layer (i),
the method comprising:
laminating the layer (ii) and a delaminatable resin layer by co-extrusion;
laminating the layer (i) on the layer (ii); and
laminating the base resin layer on the layer (i).

3. A method for producing a laminate film for coating a metal sheet for a screen board for laminating on a metal surface, wherein the laminate film comprises:
a base resin layer;
(i) a layer having elastic modulus at a temperature from 180° C. to 200° C. of 1.0×10⁷ Pa or less and elastic modulus at a temperature from 120° C. to 160° C. of 1.0×10⁸ Pa or more; and
(ii) a layer comprising a fluorine resin, as the main component, on the top of the layer (i),
the method comprising:
laminating the layer (i) and the base resin layer by co-extrusion;
laminating the layer (ii) and the delaminatable resin layer by co-extrusion; and
adhering the layer (i) and the layer (ii) to each other.

4. The method for producing a laminate film for coating a metal sheet for a screen board according to claim 1, wherein the layer (i) comprises a polycarbonate.

5. The method for producing a laminate film for coating a metal sheet for a screen board according to claim 1, wherein a thickness of the layer (ii) is 10 μm or less.

6. The method for producing a laminate film for coating a metal sheet for a screen board according to claim 1, wherein the layer (ii) comprises an ethylene-tetrafluoroethylene copolymer.

7. The method for producing a laminate film for coating a metal sheet for a screen board according to claim 1, wherein surface roughness of said laminate film is defined as: Ra, which is the center-line mean deviation of a profile, is from 0.7 μm to 5 μm; Ry, which is the maximum height of the profile, is from 4 μm to 40 μm; Rz, which is the ten-point height of irregularities, is from 3 μm to 30 μm; Rp, which is an average depth profile, is from 1.5 μm to 20 μm; Pc, which is a peak count, is from 7 to 50, and gloss of a surface is defined as 50 or less.

8. The method for producing a laminate film according to claim 2, wherein said base resin layer comprises 50 mass % or more of a substantially crystalline polyester series resin, of which a clear crystal melting peak is observed during the heating-up time when measured by differential scanning calorimetry (DSC), wherein the total mass of said base resin layer as 100 mass %.

9. A method for producing a laminate film coated metal sheet for a screen board, the method comprising:
producing the laminate film for coating a metal sheet for a screen board by the method according to claim 1, and
adhering a metal sheet to the layer (i) of said laminate film.

10. A method for producing a laminate film coated metal sheet for a screen board, the method comprising:
producing the laminate film for coating a metal sheet for a screen board by the method described in claim 2, and
adhering a metal sheet to said base resin layer of said laminate film.

11. The method for producing a laminate film for coating a metal sheet for a screen board according to claim 2, wherein the layer (i) comprises a polycarbonate.

12. The method for producing a laminate film for coating a metal sheet for a screen board according to claim 2, wherein a thickness of the layer (ii) is 10 μm or less.

13. The method for producing a laminate film for coating a metal sheet for a screen board according to claim 2, wherein the layer (ii) comprises an ethylene-tetrafluoroethylene copolymer as the main component.

14. The method for producing a laminate film for coating a metal sheet for a screen board according to claim 2, wherein surface roughness of said laminate film is defined as: Ra, which is the center-line mean deviation of a profile, is from 0.7 μm to 5 μm; Ry, which is the maximum height of the profile, is from 4 μm to 40 μm; Rz, which is the ten-point height of irregularities, is from 3 μm to 30 μm; Rp, which is an average depth profile, is from 1.5 μm to 20 μm; Pc, which is a peak count, is from 7 to 50, and gloss of a surface is defined as 50 or less.

15. The method for producing a laminate film according to claim 1, wherein the layer (i) is embossed together with the layer (ii), thereby the layer (ii) is formed along the embossing of the layer (i).

16. The method for producing the laminate film according to claim 2, wherein the layer (i) is embossed together with the layer (ii), thereby the layer (ii) is formed along the embossing of the layer (i).

17. The method for producing a laminate film according to claim 1, wherein a thickness of the layer (ii) is from 3 μm to 10 μm.

18. The method for producing a laminate film according to claim 2, wherein a thickness of the layer (ii) is from 3 μm to 10 μm.

19. The method for producing a laminate film according to claim 1, wherein a content of the fluorine resin in the layer (ii) is 50 mass % or greater.

20. The method for producing a laminate film according to claim 2, wherein a content of the fluorine resin in the layer (ii) is 50 mass % or greater.
